(19) United States
(12) Patent Application Publication
(10) Pub. No.: US 2014/0380356 A1
(43) Pub. Date: Dec. 25, 2014

(54) DEVICE AND METHOD FOR PROCESSING BI-DIRECTIONAL SERVICE RELATED TO BROADCAST PROGRAM

(71) Applicant: LG Electronics Inc., Seoul (KR)

(72) Inventors: Seungjoo Hyung An, Seoul (KR); Kyungho Yeul Kim, Seoul (KR); Jongyeul Suh, Seoul (KR); Sejin Oh, Seoul (KR); Kyoungsoo Moon, Seoul (KR); Gomer Thomas, Arlington, WA (US); Jinwon Lee, Seoul (KR); Jinpil Kim, Seoul (KR); Taejin Park, Seoul (KR); Aettie Ji, Seoul (KR)

(21) Appl. No.: 14/343,322

(22) PCT Filed: May 24, 2013
(86) PCT No.: PCT/KR2013/004567

§ 371 Date: Mar. 6, 2014

Related U.S. Application Data
(60) Provisional application No. 61/651,567, filed on May 25, 2012.
(60) Provisional application No. 61/654,053, filed on May 31, 2012.

(51) Int. Cl. H04N 21/845; H04N 21/8545; H04N 21/81; H04N 21/262; H04N 21/462; H04N 21/438; H04N 21/458; H04N 21/858; H04N 21/6377

(52) U.S. Cl. CPC H04N 21/8455; H04N 21/8586; H04N 21/8545; H04N 21/8133; H04N 21/6377; H04N 21/462; H04N 21/4383; H04N 21/458; H04N 21/26241
USPC 725/32

(57) ABSTRACT

A broadcast receiver processing an interactive service related to a broadcast program according to one embodiment of the present invention includes a tuner configured to receive a trigger information including an information on operation timing of a TDO (triggered declarative object), wherein the trigger information includes at least one of a first URL information indicating a position of a signaling server configured to provide a TDO parameter table, a first trigger identification information identifying a trigger included in the TDO, a first time information setting a reference time for the trigger, and a second time information setting operation time of the trigger, a first network interface configured to access the signaling server using the first URL information and configured to receive a TDO parameter table signaling metadata information on at least one TDO in a specific segment from the signaling server, wherein the TDO parameter table includes a second URL information indicating a position of a content server configured to provide at least one file included in the TDO and a second identification information identifying a trigger included in the TDO, a second network interface configured to access the content server using the second URL information and configured to receive at least one file included in the TDO, a widget engine configured to operate the trigger, and a video processor configured to generate a video image including a TDO by the trigger operation and a broadcast program.

### TECHNICAL FIELD

The present invention relates to a method of providing and processing a broadcast service and apparatus therefor, and more particularly, to a method of providing an additional service related to a broadcast content provided by a broadcast system and an apparatus therefor.

### BACKGROUND ART

As such technologies as broadcasting network management, an audio/video codec, a communication network used for a broadcast system and the like have been developed, a broadcast system providing a clear screen, a more clear audio, and more various contents to a viewer has become available. Moreover, a viewer is eager to receive an additional service related to broadcast content in accordance with a user experience (UX). Recently, the viewer takes on an active attitude toward the broadcast content in a manner of actively participating in the broadcast content instead of taking on a passive attitude toward the broadcast content, which is simply received by the viewer. Yet, a current broadcast system has not constructed a system appropriate enough to satisfy the demand of the viewer. For instance, the current broadcast system has no technical preparation for a timing point on which additional information related to a specific broadcast content is provided and a processing method by which the additional information related to the specific broadcast content is provided.

### DISCLOSURE OF THE INVENTION

### Technical Task

A technical task that the present invention intends to achieve is to solve the aforementioned problem, i.e., to provide additional information related to broadcast content on an appropriate timing point using a broadcasting system while the broadcast content is played.

### Technical Solution

To achieve these and other advantages and in accordance with the purpose of the present invention, as embodied and broadly described, according to one embodiment of the present invention, a broadcast receiver, which processes an interactive service related to a broadcast program, includes a tuner configured to receive a trigger information including an information on operation timing of a TDO (triggered declarative object), wherein the trigger information includes at least one of a first URL information indicating a position of a signaling server configured to provide a TDO parameter table, a first trigger identification information identifying a trigger included in the TDO, a first time information setting a reference time for the trigger, and a second time information setting operation time of the trigger; a first network interface configured to access the signaling server using the first URL information and configured to receive a TDO parameter table signaling metadata information on at least one TDO in a specific segment from the signaling server, wherein the TDO parameter table includes a second URL information indicating a position of a content server configured to provide at least one file included in the TDO and a second identification information identifying a trigger included in the TDO; a second network interface configured to access the content server using the second URL information and configured to receive at least one file contained in the TDO; a widget engine configured to set a reference time for a trigger identified by the second identification information with the reference time configured by the first time information in a manner of matching the second identification information with the first identification information, configured to set operation time for a trigger identified by the second identification information with the operation time configured by the second time information, and configured to operate the trigger on the set operation time; and a video processor configured to generate a video image containing a TDO by the trigger operation and a broadcast program.

Preferably, the trigger information is transmitted in a manner of being included in a region in which a closed caption included in a video header of a broadcast signal is transmitted.

Preferably, the TDO parameter table further includes trigger operation information indicating an operation of the trigger identified by the second identification information.

Preferably, the TDO parameter table further includes internet validity information indicating whether the TDO is downloadable via the internet.

Preferably, the TDO parameter table further includes broadcast network validity information indicating whether the TDO is capable of being received by a broadcast network.

To further achieve these and other advantages and in accordance with the purpose of the present invention, according to one embodiment of the present invention, a method of processing an interactive service related to a broadcast program includes the steps of generating trigger information including an information on operation timing of a TDO (triggered declarative object), wherein the trigger information includes at least one of a first URL information indicating a position of a signaling server configured to provide a TDO parameter table, a first trigger identification information identifying a trigger included in the TDO, a first time information setting a reference time for the trigger, and a second time information setting operation time of the trigger, generating a TDO parameter table signaling metadata information on at least one TDO in a specific segment, wherein the TDO parameter table includes a second URL information indicating a position of a content server configured to provide at least one file included in the TDO and a second identification information identifying a trigger included in the TDO, generating a broadcast signal including the generated trigger information, and transmitting the generated TDO parameter table to the signaling server, wherein the second identification information performs a role of connecting the TDO parameter table with the trigger information in a manner of being matched with the first identification information, wherein the first time information included in the trigger information uses the reference time configured by the first time information to configure a reference time for a trigger identified by the second identification information included in the connected TDO parameter table, wherein the second time information included in the trigger information uses the operation time configured by the second time information to configure operation time for a trigger identified by the second identification information included in the connected TDO parameter table.

Preferably, the step of generating a broadcast signal including the generated trigger information includes the step of generating the broadcast signal in a manner of including the trigger information in a region in which a closed caption included in a video header of a broadcast signal is transmitted.

Preferably, the TDO parameter table further includes trigger operation information indicating an operation of the trigger identified by the second identification information.

Preferably, the TDO parameter table further includes internet validity information indicating whether the TDO is downloadable via the internet.

Preferably, the TDO parameter table further includes broadcast network validity information indicating whether the TDO is capable of being received by a broadcast network.

### Advantageous Effects

According to the present invention, additional information related to broadcast content can be provided using a conventional broadcast system.

According to the present invention, additional information can be provided to a user on an appropriate timing point in a manner that a timing point on which additional information related to broadcast content should be displayed is precisely identified.

According to the present invention, a broadcast receiver incapable of directly receiving a broadcast signal can obtain additional information related to broadcast content and can provide additional information on an appropriate timing point to a viewer.

### DESCRIPTION OF DRAWINGS

FIG. 1 is a diagram for a concept of a real time (RT) service and a non-real time (NRT) service according to one embodiment of the present invention;

FIG. 2 is a diagram for a structure of signaling an NRT service according to one embodiment of the present invention;

FIG. 3 is a diagram of an NRT-IT (NRT information table) according to one embodiment of the present invention;

FIG. 4 is a diagram for a structure of a broadcast stream according to one embodiment of the present invention;

FIG. 5 is a diagram for a structure of a time base message and mode information capable of being included in the time base message according to one embodiment of the present invention;

FIG. 6 is a diagram for an Interactive_service_content_information block according to one embodiment of the present invention;

FIG. 7 is a diagram for a section of an interactive service content information table (ISC-IT) according to one embodiment of the present invention;

FIG. 8 is a diagram for an ISCIB header according to one embodiment of the present invention;

FIG. 9 is a diagram for a trigger information block according to one embodiment of the present invention;

FIG. 10 is a diagram for a trigger action indicated by trigger_action information according to one embodiment of the present invention;

FIG. 11 is a diagram for an Interactive Service Trigger information Table (IST-IT) section according to one embodiment of the present invention;

FIG. 12 is a diagram for a part of a TDO parameter table (TPT) according to one embodiment of the present invention;

FIG. 13 is a diagram for a different part of a TDO parameter table (TPT) according to one embodiment of the present invention;

FIG. 14 is a diagram for internet_location_descriptor according to one embodiment of the present invention;

FIG. 15 is a diagram for capabilities_descriptor according to one embodiment of the present invention;

FIG. 16 is a diagram for an activation message according to one embodiment of the present invention;

FIG. 17 is a diagram for a broadcast system transmitting a time base message and/or an activation message on an ES in a segment-oriented mode according to one embodiment of the present invention;

FIG. 18 is a diagram for a broadcast system transmitting a time base message and/or an activation message on a DTV-CC in a segment-oriented mode according to one embodiment of the present invention;

FIG. 19 is a diagram for a broadcast system transmitting a time base message and/or an activation message on a PES in a service-oriented mode according to one embodiment of the present invention;

FIG. 20 is a diagram for a broadcast system transmitting a time base message and/or an activation message on a DTV-CC in a service-oriented mode according to one embodiment of the present invention;

FIG. 21 is a diagram for MPEG2-TS transmitting a time base message according to one embodiment of the present invention;

FIG. 22 is a diagram for a time base message descriptor according to one embodiment of the present invention;

FIG. 23 is a diagram for MPEG2-TS transmitting a time base message according to a different embodiment of the present invention;

FIG. 24 is a diagram for an EXT1 code including a data of a time base message according to one embodiment of the present invention;

FIG. 25 is a diagram for Time_Base_Message( ) included in an EXT1 code according to one embodiment of the present invention;

FIG. 26 is a diagram for a schema of a time base message and XSD syntax according to one embodiment of the present invention when the time base message is transmitted via the internet;

FIG. 27 is a diagram for a structure to signal a content item according to one embodiment of the present invention when the content item is executed in a segment of a service;

FIG. 28 is a diagram for a structure to signal a content item according to one embodiment of the present invention when pluralities of the content items are executed in a segment of a service;

FIG. 29 is a diagram for a method of signaling an interactive service using a broadcast network in a segment-oriented mode according to one embodiment of the present invention;

FIG. 30 is a diagram for a method of signaling an interactive service using a broadcast network in a service-oriented mode according to one embodiment of the present invention;

FIG. 31 is a diagram for a schema of interactive service information according to one embodiment of the present invention;

FIG. 32 is a diagram for interactive service information of an XSD form according to one embodiment of the present invention;

FIG. 33 is a diagram for a schema of interactive service information according to a different embodiment of the present invention;

FIG. 34 is a diagram for interactive service information of an XSD form according to one embodiment of the present invention;

FIG. 35 is a diagram for an activation message descriptor according to one embodiment of the present invention;

FIG. 36 is a diagram for an activation message descriptor according to a different embodiment of the present invention;

FIG. 37 is a diagram for an activation message descriptor according to a further different embodiment of the present invention;

FIG. 38 is a diagram for an EXT1 code format including a data of an activation message according to one embodiment of the present invention;

FIG. 39 is a diagram for an Activation Message( ) included in an EXT1 code according to one embodiment of the present invention;

FIG. 40 is a diagram for an Activation Message( ) included in an EXT1 code according to a different embodiment of the present invention;

FIG. 41 is a diagram for a schema to transmit an activation message on the internet and XDS syntax according to one embodiment of the present invention;

FIG. 42 is a diagram for a schema to transmit an activation message on the internet and XDS syntax according to a different embodiment of the present invention;

FIG. 43 is a diagram for a process of operating a TDO according to one embodiment of the present invention when an NRT service is supported in a state that a receiver is not connected to the internet;

FIG. 44 is a diagram for a process of operating a TDO according to one embodiment of the present invention when an NRT service is supported in a state that a receiver is connected to the internet;

FIG. 45 is a diagram for a process of operating a TDO according to one embodiment of the present invention when an NRT service is not supported, although a receiver is connected to the internet;

FIG. 46 is a diagram for a process of operating a TDO operated by an ACR receiver according to one embodiment of the present invention;

FIG. 47 is a diagram for a broadcast transmission system according to one embodiment of the present invention;

FIG. 48 is a diagram for a broadcast receiver according to one embodiment of the present invention;

FIG. 49 is a flowchart of a method of processing an interactive service related to a broadcast program according to one embodiment of the present invention.

### BEST MODE

Reference will now be made in detail to the preferred embodiments of the present invention, examples of which are illustrated in the accompanying drawings. In this case, composition and action of the present invention depicted in the drawings and explained by the drawings are explained as at least one embodiment of the present invention, by which the technical idea, core composition, and action of the present invention may be non-limited.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

Among the terminologies used in the present invention, a real time (RT) service literally means a real time service. In particular, the real time service is a service restrained by time. On the contrary, a non-real time (NRT) service means a non-real time service except the RT service. In particular, the non-real time service is a service not restrained by time. And, assume that data required for the NRT service is called a NRT service data.

A broadcast receiver according to the present invention can receive a non-real time (NRT) service via such a media as a ground wave, a cable, the internet, and the like. The NRT service is stored in a storing media of the broadcast receiver and then displayed in a display device according to predetermined time or a request of a user. One embodiment of the NRT service is to be stored in the storing media in a manner of being received in a file form. The storing media may correspond to an internal HDD installed in the broadcast receiver. As a different example, the storing media may correspond to a USB (universal serial bus) memory, an external HDD, or the like connected to the external of a broadcast reception system. In order to store files composing the NRT service in the storing media by receiving the files and provide the NRT service to a user, signaling information is required. The signaling information is called NRT service signaling information or an NRT service signaling data in the present invention. The NRT service according to the present invention can be classified into a fixed NRT service and a mobile NRT service depending on a scheme of obtaining IP datagram. In particular, the fixed NRT service is provided to a fixed broadcast receiver and the mobile NRT service is provided to a mobile broadcast receiver. The present invention is explained on the basis of the fixed NRT service as one embodiment. Yet, it is apparent that the present invention is applicable to the mobile NRT service as well.

Among the terminologies used in the present invention, an interactive adjunct service is a data service providing an interactive experience to a viewer to enhance a viewing experience. The interactive adjunct service includes a TDO, a DO, or a NDO.

Among the terminologies used in the present invention, a trigger is a signaling element configured to identify a signaling and set a timing point of providing an interactive service or an interactive event. The trigger can play a role of a time base trigger and/or an activation trigger. The time base trigger is used to set a time base providing a criterion of an event playback time. The activation trigger is used to set an event operation time. A time base message, which shall be described later, can be used as the time base trigger or the time base trigger can be used as the time base message. An activation message, which shall be described later, can be used as the activation trigger or the activation trigger can be used as the activation message.

The time base message is a message transmitting a timestamp sampled in a time clock. It shall be described in detail later.

The activation message is a message transmitting a timestamp indicating a trigger operation or a start time of an event. It shall be described in detail later.

A media time is a parameter to refer to a specific time in case of a content playback.

A TDO (triggered declarative object) indicates additional information within a broadcast content. The TDO triggers the additional information within the broadcast content in accordance with timing. For instance, when an audition program is broadcasted, a current rank of an audition participant preferred by a viewer and the like can be viewed together with a corresponding broadcast content. In this case, additional information on the current rank of the audition participant and the like may become the TDO. The TDO can be modified by an interactive communication with a viewer or provided in a manner of reflecting an intention of the viewer.

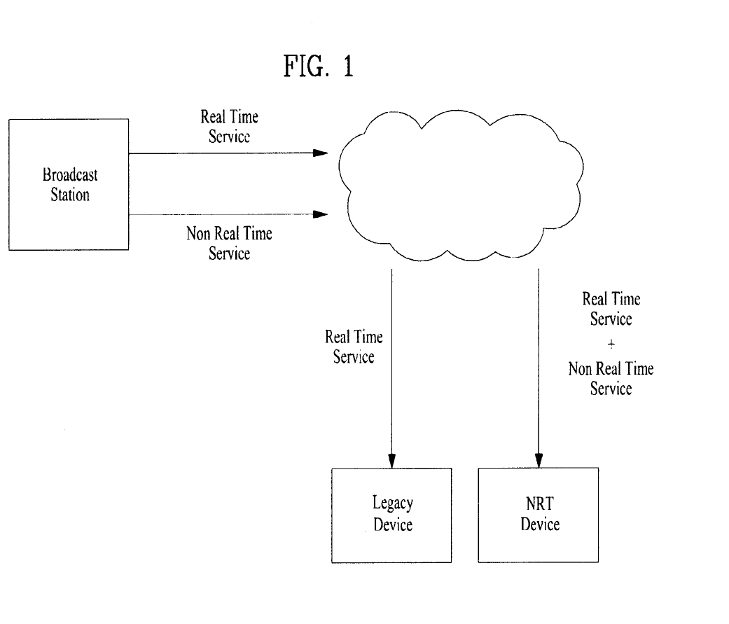

FIG. 1 is a diagram for a concept of a real time (RT) service and a non-real time (NRT) service according to one embodiment of the present invention.

A broadcasting station transmits a real time service according to such a conventional scheme as a current ground wave broadcasting (or mobile broadcasting). In this case, the broadcasting station can provide a non-real time service using an extra bandwidth, which is remained in a process of transmitting the real time service, or a dedicated bandwidth. In particular, the real time service and the non-real time service are transmitted on an identical channel or channels different from each other. Hence, a broadcast receiver distinguishes the real time service from the non-real time service and stores the distinguished non-real time service. And then, it is necessary to have a non-real time service signaling information (or NRT service signaling data) to provide the distinguished non-real time service to a user if necessary. The non-real time service signaling information (or NRT service signaling data) shall be described in detail later. For instance, the broadcasting station can transmit a broadcast service data in real time and may transmit a news clip, weather information, a commercial, push VOD, and the like in non-real time. And, a non-real time service may correspond to specific scenes among a real time broadcast stream, detail information of a specific program, a preview, and the like as well as the news clip, the weather information, the commercial, and the push VOD.

A legacy broadcast receiver, i.e., a legacy device can process a real time service in a manner of receiving the real time service. Yet, the legacy device cannot process a non-real time service in a manner of receiving the non-real time service. In particular, it is a principle that an operation of the legacy broadcast receiver, i.e., the legacy device is not affected by a non-real time stream included in a channel on which the real time service is transmitted. In other word, the legacy broadcast receiver cannot process a received non-real time service even though the legacy broadcast receiver receives the non-real time service. It is because a means capable of appropriately processing the non-real time service is not installed in the broadcast receiver.

On the contrary, since a broadcast receiver, i.e., NRT device according to the present invention receives a non-real time service combined with a real time service and can appropriately process the non-real time service, the NRT device can provide various functions to a viewer compared to the legacy broadcast receiver.

According to one embodiment, a non-real time service according to the present invention includes at least one content item (also called content or NRT content) and the content item includes at least one file. In the present invention, both a file and an object are used as an identical meaning. The content item is a minimum unit capable of being independently played. For instance, if there exists a news provided in non-real time and the news includes business news, political news, and living news, the news may corresponds to the non-real time service and each of the business news, the political news, and the living news may correspond to the content item. And, each of the business news, the political news, and the living news consists of at least one file.

In this case, the non-real time service can be transmitted in a form of MPEG-2 transport stream (TS) packet on a broadcast channel identical to a channel on which a real time service is transmitted or a dedicated broadcast channel. In this case, a unique PID is transmitted in a manner of being assigned to a TS packet of an NRT service data to identify the non-real time service. According to one embodiment of the present invention, an IP-based NRT service data is transmitted in a form of MPEG-2 TS packet.

In this case, NRT service signaling data necessary to receive the NRT service data is transmitted on an NRT service signaling channel. The NRT service signaling channel is transmitted via a specific IP stream on an IP layer. In this case, the IP stream is also transmitted in the form of MPEG-2 TS packet. The NRT service signaling data transmitted on the NRT service signaling channel includes an NRT service map table (SMT) and/or an NRT information table (NRT-IT). According to one embodiment, the SMT provides access information of content item/files, which compose at least one non-real time service operating on the IP layer. According to one embodiment, the NRT-IT provides detail information of the content item/files composing a non-real time service. In the present invention, the SMT and the NRT-IT are also called a signaling information table.

According to one embodiment of the present invention, besides broadcast content, a TDO can be transmitted in real time service or a non-real time service. And, the TDO can be transmitted via an internet network instead of a broadcast network.

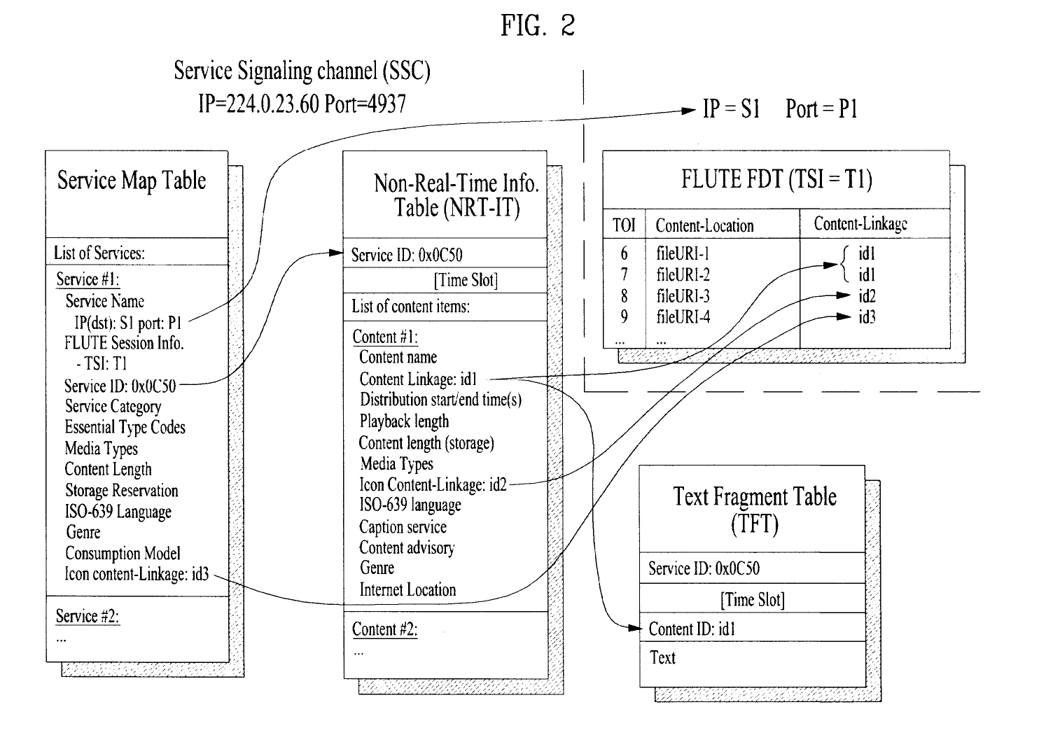

FIG. 2 is a diagram for a structure of signaling an NRT service according to one embodiment of the present invention.

The SMT and the NRT-IT can be transmitted on a channel, i.e., a service signaling channel (SSC) including a specific IP address and a port number.

The SMT according to one embodiment of the present invention can include signaling information for a plurality of NRT services. The SMT can include service name information, IP and port information, FLUTE session information, service ID information, service category information, content length information, storage reservation information, ISO-639 language information, genre information, and/or icon content linkage information for each of a plurality of the NRT services.

The service name information is information indicating a name of an NRT service and can be used for an interaction with a user. In particular, a user recognizes a corresponding service by the name of the NRT service and makes a request for the corresponding service.

The IP and port information indicates an IP address and port number providing an NRT service.

The FLUTE session information indicates a FLUTE (file delivery over unidirectional transport) session transmitting a file related to an NRT service.

The service ID information is an identifier identifying an NRT service. The service ID information can be used as a linkage linking to the NRT-IT.

The service category information indicates a category of a service. For instance, the service category may indicate where a service belongs to among an RT service, an IP service, an EPG service, or an NRT service.

The content length information is information used to indicate length of contents included in an NRT service.

The storage reservation information is information indicating capacity of a storing device, which needs a reservation to be provided with an NRT service.

The ISO-639 language information is information on a language used in an NRT service.

The genre information is information indicating a genre of an NRT service.

The icon content linkage information is connection information on an icon explaining an NRT service. If the icon content linkage information is matched with content-linkage information of FLUTE FDT (file delivery table), it is used to enable a receiver to receive an icon in an address indicated by content-location information related to a corresponding content-linkage.

The NRT-IT according to one embodiment of the present invention can include information on a plurality of NRT contents. The NRT-IT can include service ID information, content name information, content linkage information, distribution start/end time information, playback length information, content length information, media type information, icon content-linkage information, ISO-639 language information, caption service information, content advisory information, genre information, and/or internet location information for each of a plurality of the NRT contents.

If the icon content linkage information is matched with content-linkage information of FLUTE FDT, it is used to enable a receiver to receive a file composing NRT content in an address indicated by content-location information related to a corresponding content-linkage. The content linkage information can be used as a linkage linking the NRT-IT to a TFT (text fragment table). The TFT includes a text fragment used to provide explanation on an NRT service or NRT content. In particular, the TFT transmits a data structure supporting a plurality of languages and the corresponding data structure includes data configured to provide explanation on the NRT service or the NRT content with a plurality of different languages.

The icon content-linkage information is connection information on an icon explaining the NRT content. If the icon content linkage information is matched with content-linkage information of FLUTE FDT, it is used to enable a receiver to receive an icon in an address indicated by content-location information related to a corresponding content-linkage.

Detail contents on the information included in the NRT-IT shall be described in detail later.

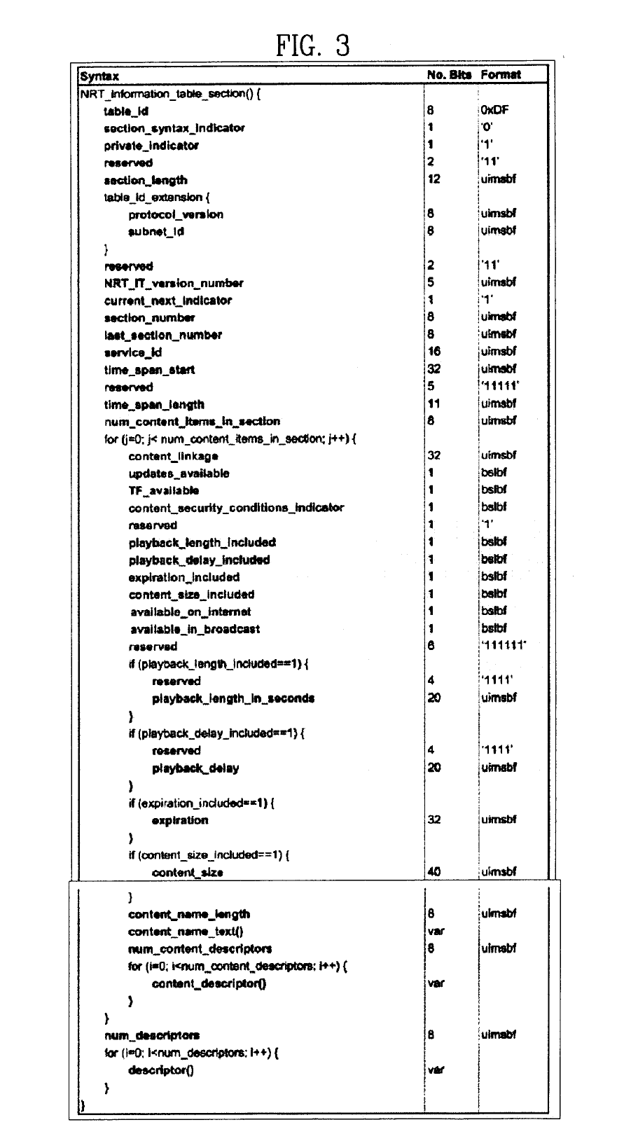

FIG. 3 is a diagram of an NRT-IT (NRT information table) according to one embodiment of the present invention.

The NRT-IT according to one embodiment of the present invention includes table_id information, protocol_version information, subnet_id information, NRT_IT_version_number information, current_next_indicator information, section_number information, last_section_number information, service_id information, time_span_start information, time_span_length information, num_content_items_in_section information, content_linkage information, updates_available information, TF_available information, content_security_conditions_indicator information, playback_length_included information, playback_delay_included information, expiration_included information, content_size_included information, available_on_internet information, available_in_broadcast information, playback_length_in_seconds information, playback_delay information, expiration information, content_size information, content_name_length information, content_name_text( ) information, num_content_descriptors information, content_descriptor( ) information, num_descriptors information, and/or descriptor( ) information.

The table_id information is information to identify a type of a corresponding table section. The present table_id information indicates the corresponding table section composing the NRT-IT.

The protocol_version information indicates version information of a NRT-IT structure. The protocol_version information may include 8-bit. A first 4-bit indicates a major version number and a last 4-bit indicates a minor version number. A change of the major version number indicates a change of the NRT-IT structure in a range that compatibility with a legacy NRT-IT is not maintained. A change of the minor version number indicates a change of the NRT-IT structure in a range that compatibility with a legacy NRT-IT is maintained.

The subnet_id information indicates an IP subnet related to a service signaling channel.

The NRT_IT_version_number information indicates a version number of an NRT-IT instance. The NRT-IT instance can be identified by a combination of the service_id information, the table_id information, table_id_extension information and the time_span_start information.

The current_next_indicator information is information indicating whether information of the NRT-IT is applied now or applied later. The information of the NRT-IT can be currently applied at any time, the current_next_indicator information will be set to ‘1’.

The section_number information indicates a section number of an NRT-IT section.

The last_section_number information indicates a section number of a last NRT-IT section in the NRT-IT section included in the NRT-IT.

The service_id information identifies a service_id related to an NRT service, which provides NRT content explained in the NRT-IT section.

The time_span_start information indicates a start time of a duration covered by the NRT-IT instance.

The time_span_length information indicates a sustainment time of a duration covered by the NRT-IT instance.

The num_content_items_in_section information indicates the number of NRT contents explained by the NRT-IT section.

The content_linkage information indicates an identification number of NRT content. The content_linkage information performs a role of linking files, which compose at least one NRT content of FLUTE FDT related to the NRT content in the NRT-IT. The content_linkage information performs a role of linking the NRT-IT to the TFT.

The updates_available information is information indicating whether an update related to NRT content is available.

The TF-available information is information indicating whether a text fragment for NRT content exists within the TFT of a service signaling channel.

The content_security_conditions_indicator information is information indicating whether a content protection is applied to at least one file that composes the NRT content.

The playback_length_included information is information indicating whether the playback_length_in_seconds information is included in a loop for the NRT content.

The playback_delay_included information is information indicating whether the playback_delay information is included in a loop for the NRT content.

The expiration_included information is information indicating whether the expiration information is included in a loop for the NRT content.

The content_size_included information is information indicating the content_size information is included in a loop for the NRT content.

The available_on_internet information is information indicating whether a file included in the NRT content can be obtained via an internet connection.

The available_in_broadcast information is information indicating whether a file included in the NRT content can be obtained via a broadcast network.

The playback_length_in_seconds information is information indicating playback time of the NRT content in a unit of a second.

The playback_delay information indicates a time for which a receiver should waits until the receiver playbacks corresponding NRT content while buffering received stream after the receiver has received a first byte of the NRT content.

The expiration information is information indicating a time by which the NRT content is ended. If a current time is later than the time indicated by the expiration information, a receiver can delete the corresponding NRT content from a memory based on this information.

The content_size information is information indicating a size of the NRT content. Before downloading the NRT content, a receiver can check whether there exists a memory sufficient to receive/store the corresponding NRT content in the receiver based on this information.

The content_name_length information is information indicating a length of the content_name_text( ) information.

The content_name_text( ) information is information indicating a name of the NRT content in a format of a multiple string structure.

The num_content_descriptors information is information indicating the number of descriptors following the num_content_descriptors information.

The content_descriptor( ) information can include a descriptor of at least one MPEG-2 descriptor format to provide information on the NRT content.

The num_descriptors information indicates the number of descriptors following the num_descriptors information.

The descriptor( ) information may include a descriptor of more than 0 MPEG-2 descriptor format to provide information commonly applied for all of the NRT contents explained by the NRT-IT.

If a TDO is transmitted in NRT, the information included in the aforementioned NRT-IT can be used to explain the TDO.

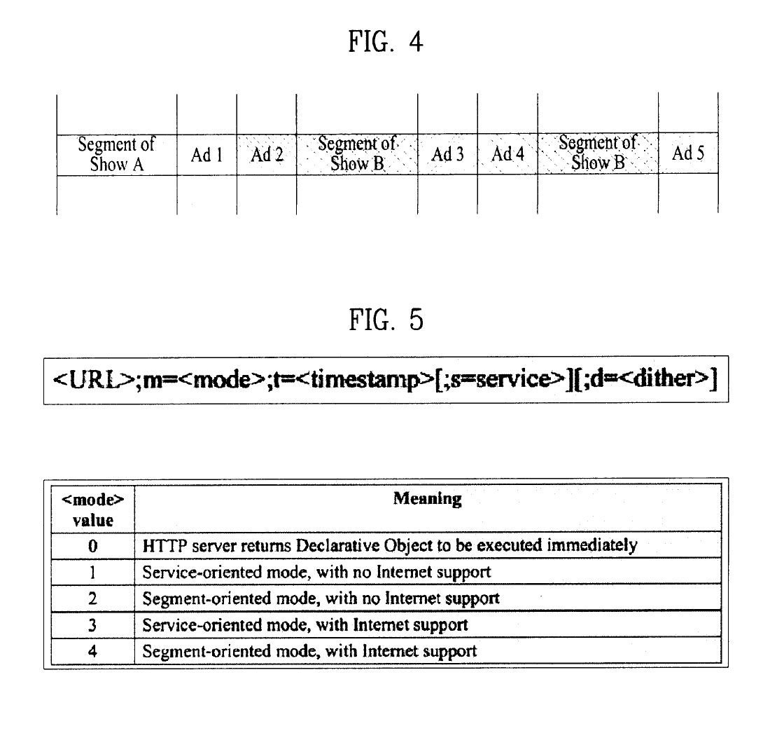

FIG. 4 is a diagram for a structure of a broadcast stream according to one embodiment of the present invention.

A broadcast stream includes a sequence of a TV program. Each of the TV programs includes a subordinate show. The subordinate show includes at least one show segment. A commercial can be included between the show segments. Or, content of a different form may be scattered between the show segments.

In the present invention, the commercial between the show segments or a segment including the content of a different form can be called an interstitial segment.

In order to name a part of an interactive adjunct service, a terminology called an interactive service segment can be used in the present invention.

Referring to FIG. 4, a broadcast stream includes a segment included in a show A, segments included in a show B, a segment for an Ad 1 and a segment for an Ad 2 between the segment included in the show A and the segment included in the show B, a segment for an Ad 3 and a segment for an Ad 4 between the segments included in the show B, and/or a segment for an Ad 5.

The segment for the Ad 1 and the Ad 2 is the segment for an Ad performed before a different show starts in case that a show has ended. The segment for the Ad 3 and the Ad 4 corresponds to the segments for an Ad occurring in the middle of a show.

The interactive service segment can be provided in relation to a show segment or an interstitial segment.

Or, the interactive service segment can be provided in relation to a set of show segments or a set of the interstitial segments. For instance, since there exist 2 segments included in the show B, one interactive service segment can be provided for the set of the segments included in the show B.

As mentioned in the foregoing description, the interactive adjunct service can be defined in a manner of being connected with each of the segments. The aforementioned case may be defined as a segment-oriented mode.

As a different embodiment, the interactive adjunct service can be defined in a manner of being connected with a service unit. The aforementioned case may be defined as a service-oriented mode. For instance, both interactive adjunct services connected with a virtual channel and signaling information for the interactive adjunct services are defined all at once and may be transmitted from a transmission end to a reception end.

In order for the interactive adjunct service connected with broadcast content to be provided to a viewer in a timely manner, a position and attribute information of a TDO provided in two-way, a position and attribute information of a file or a real time data stream used by the TDO, trigger information used to determine an operation of the TDO performed on a specific time, an activation message indicating a time on which a trigger is activated, and/or a time base message configured to define a reference time for the activation message should be provided as the signaling information for the interactive adjunct services. In this case, as mentioned in the foregoing description, the activation message or the time base message can be defined as a part of the trigger information.

FIG. 5 is a diagram for a structure of a time base message and mode information capable of being included in the time base message according to one embodiment of the present invention.

In case that a time base message is transmitted via a broadcast network, the time base message can be transmitted via a region for a closed caption of a video header.

The time base message according to one embodiment of the present invention is defined as a form including URL information. Mode information, timestamp information, service information, and/or dither information can be additionally defined in the URL information in a URL form.

The URL information indicates a position of a server supporting a TDO or an interactive adjunct service. In particular, the URL information indicates the position of the server providing information on the interactive adjunct service or the TDO. The URL information can be used as an identifier identifying a time base. According to one embodiment of the present invention, the information on the TDO may correspond to a TDO parameter table (TPT). In one embodiment of the present invention, the information on the interactive adjunct service and the information on the TDO may be used as an identical meaning.

The mode information indicates a type of support capable of being supported by a server of a position identified by the URL information. Referring to FIG. 5, if a value of the mode information corresponds to ‘0’, an HTTP server returns a DO (declarative object) to be executed immediately. In particular, a receiver generates information used for the DO while receiving the DO from the HTTP server.

In case that the value of the mode information corresponds to ‘1’ or ‘2’, the receiver receives the signaling information configured to provide the interactive adjunct service and/or the interactive adjunct service from a broadcast network. In this case, the signaling information configured to provide the interactive adjunct service includes information related to the TDO.

In case that the value of the mode information corresponds to ‘3’ or ‘4’, similar to the case that the value of the mode information corresponds to ‘1’ or ‘2’, the receiver can receive the signaling information and/or the interactive adjunct service from a broadcast network. Or, the receiver can receive the signaling information from the broadcast network and can download the interactive adjunct service via the internet, respectively. Or, the receiver can download the signaling information and the interactive adjunct service via the internet.

The service-oriented mode and the segment-oriented mode can be identified depending on a value of the mode information. In case of the service-oriented mode, a time base is applied to all segments within the interactive adjunct service. In case of the segment-oriented mode, a time base can be applied to segments including a segment ID matched with an ID of the time base identified by the URL information only.

The timestamp information indicates a value sampled from a clock providing a time base. In this case, the time base is a reference time used to determine a timing point of playback of an event including an interactive adjunct service.

The service information identifies a service_id of an interactive adjunct service of which a time base is to be used.

The dither information indicates a time interval configured to disperse a query for a server to disperse a workload of the server.

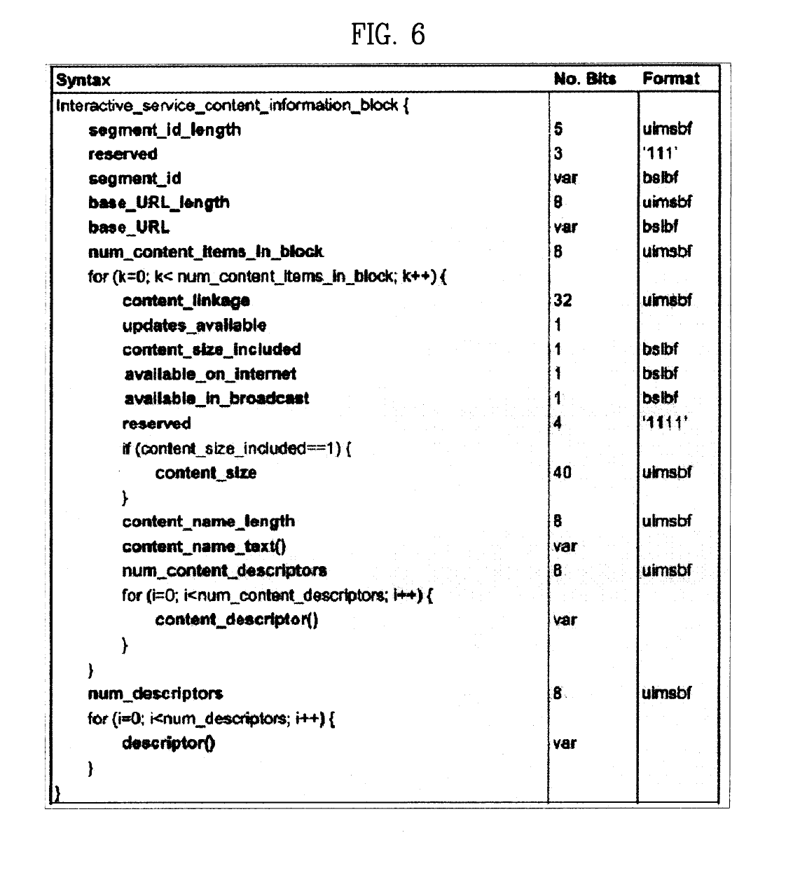

FIG. 6 is a diagram for an Interactive_service_content_information block according to one embodiment of the present invention.

The Interactive_service_content_information block according to one embodiment of the present invention forms a basic building block for a data on an attribute and a position of a TDO or different files. Or, the Interactive_service_content_information block may become a basic building block for a live data used in the TDO. For instance, the live data used in the TDO may correspond to content periodically updated.

In this case, the content or content item can include a TDO.

The Interactive_service_content_information block includes segment_id_length information, segment_id information, base_URL_length information, base_URL information, num_content_items_in_section information, content_linkage information, updates_available information, content_size_included information, available_on_internet information, available_in_broadcast information, content_size information, content_name_length information, content_name_text( ) information, num_content_descriptors information, content_descriptor( ) information, num_descriptors information, and/or descriptor( ) information.

The segment_id_length information indicates a length of segment_id information.

The segment_id information is an identifier of an interactive service segment related to the Interactive_service_content_information block. As an embodiment, this identifier can be used as a URI form, which is permitted to use by a user to which the segment_id information is assigned.

The base_URL_length information indicates a length of the base_URL information.

The base_URL information indicates a base URL indicating an absolute URL of files. The base URL can be connected to a front end of a related URL indicated in an internet location descriptor capable of being included in the Interactive_service_content_information block.

The num-content_items_in_section information indicates the number of content items (or contents) explained in the Interactive_service_content_information block.

The content_linkage information indicates an identification number of the content item. The identification number has a unique value in a range of a segment identified by the segment_id information. If the content item corresponds to a TDO, the content_linkage information is used to identify the TDO as a target of a trigger.

The updates_available information is information indicating whether the content item is periodically updated. For instance, a value of the updates_available information is set to ‘1’, it may indicate that the content item is periodically updated. In this case, a receiver can monitor a transmission mechanism for a new version of files included in the content item. If the content item is transmitted by a broadcast network via FLUTE, the receiver can monitor a FLUTE session to update the files included in the content item. If the content item is transmitted via the internet, the receiver can establish a HTTP streaming session with a server transmitting the content item. As a different example, if the value of the updates_available information is set to ‘0’, it indicates that an update for the content item is not provided.

The content_size_included information indicates whether the content_size information is included in for loop, which explains the content item.

The available_on_internet information indicates whether files included in the content item are capable of being received via the internet.

The available_in_broadcast information indicates whether files included in the content item are capable of being received via a broadcast network.

The content_size information indicates the total size of the content item or content items in byte. Before downloading the content item or the content items, a receiver can check whether there exist memory sufficient enough to store the content item or the content items using this information. If the content_size information does not exist, a size of the content item can be identified by default_content_size information within NRT_service_descriptor, which may exist in the SMT.

The content_name_length information is information indicating a length of the content_name_text( ) information.

The content_name_text( ) information indicates a name of the content item. The name of the content item may have a form of a plurality of string structures.

The num_content_descriptors information indicates the total numbers of descriptors in a following descriptor list.

The content_descriptor( ) information may include a descriptor of at least one MPEG-2 descriptor form to provide information on each of the content items in a content item level descriptor loop.

The num_descriptors information indicates the number of following descriptors.

The descriptor( ) information includes a descriptor of at least one MPEG-2 descriptor form capable of being appeared in an Interactive_service_content_information level descriptor to provide common information on all contents explained in the Interactive_service_content_information block.

The internet location descriptor, which indicates a position of files included in the content item, can be appeared in the content_descriptor( ) loop of each of the content items within the Interactive_service_content_information block. The internet location descriptor can be used to obtain a file of the content item from an internet server and/or a FLUTE session according to the available_on_internet information and/or the available_in_broadcast information. Detail content on the internet location descriptor shall be described later.

Declarative object descriptor can be appeared in the content_descriptor( ) loop of each TDO within the Interactive_service_content_information block.

Capabilities descriptor can be appeared in the content_descriptor( ) loop of the content item and/or descriptor_loop( ) of the block. Detail contents on the capabilities descriptor shall be described later.

If the Interactive_service_content_information block (ISCIB) is delivered via a broadcast network, it can be delivered in a form of an interactive service content information table (ISC-IT).

For an interactive service operating in the service-oriented mode, the ISC-IT for the interactive service may include a plurality of ISC-IT instances. Each of the ISC-IT instances includes time span information and ISCIB information for an interactive service segment for a period indicated by the time span information. Each of the ISC-IT instances can be identified by a start time of the time span.

For an interactive service operating in the segment-oriented mode, the ISC-IT can be configured by a single instance. The instance does not include information on the time span and does not include a time limit for the ISCIB information included in the instance. In this case, the instance includes the ISCIB for a current segment or the ISCIB for at least one future segment.

Each of the ISC-IT instances may include at least one section. If the ISC-IT is transmitted via a broadcast network, each of the sections can be transmitted on a service signaling channel of a virtual channel including an interactive service related to broadcast content.

If necessary, one ISCIB can be transmitted in a manner of being divided into a plurality of sections of the ISC-IT instance. Each of the ISCIB may start on a start point of a section. If one ISCIB is transmitted in a manner of being divided into a plurality of the sections, the ISCIB is divided into a plurality of ISCIB portions and each of the divided ISCIB may include information on each of the content items within the original ISCIB.

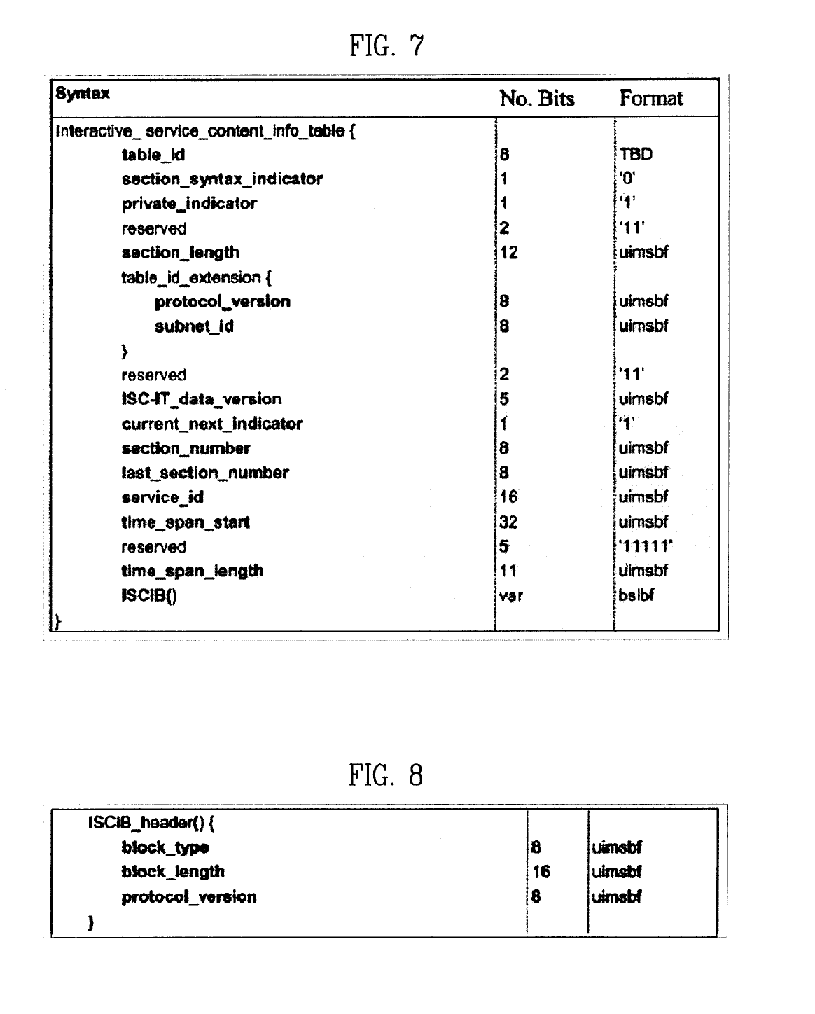

FIG. 7 is a diagram for a section of an interactive service content information table (ISC-IT) according to one embodiment of the present invention.

A section of the IST-IT includes table_id information, protocol_version information, subnet_id information, ISC_IT_data_version information, current_next_indicator information, section_number information, last_section_number information, service_id information, time_span_strat information, time_span_length information, and/or ISCIB( ) information.

The table_id information is information configured to identify the section belonging to the ISC-IT.

The protocol_version information is information indicating a protocol version and can be configured with 8 bits. An upper 4-bit indicates a major version number and a lower 4-bit indicates a minor version number.

If this section is transmitted on a broadcast stream, the subnet_id information indicates an IP subnet related to a service signaling channel in which this section is appeared. If this section is transmitted via the internet, the subnet_id information is set in a manner of being identical to a value of the subnet_id information within the broadcast stream.

The ISC_IT_data_version information indicates a version number of an IST-IT instance. Each of the ISC-IT instances can be identified by a combination of values of the table_id information, the table_id_extension information, the service_id information, and the time_span_start information.

The current_next_indicator information is information indicating that this section is currently applied or shall be applied in the future. As an example, a currently available ISC-IT can be always transmitted. In this case, this information can be always set to ‘1’.

The section_number information indicates a section number of an ISC-IT instance. The ISC-IT instance can be identified by a combination of values of the table_id information, the table_id_extension information, the service_id information, and the time_span_start information. The section_number information of a first section within the ISC-IT instance can be set to ‘0x00’ and a value of the section_number information may increase by ‘1’ on every additional section.

The last_section_number information indicates a section number of a last section of an ISC-IT instance.

The service_id information is a service identifier related to an interactive service providing the content item explained in the IST-IT instance.

The time_span_start information indicates a start of a time span covered by the IST-IT instance.

The time_span_length information indicates a length of a time span covered by the ISC-IT instance from a start time identified by the time_span_start information. Identical time_span_length information can be applied to each of a plurality of sections included in the IST-IT instance.

The ISCIB( ) information can include ISCIB data. Total of the ISCIB data for a segment or a part of the ISCIB, which includes information within a loop for the content item of the ISCIB only, can be included in the ISCIB( ) information.

FIG. 8 is a diagram for an ISCIB header according to one embodiment of the present invention.

In case of transmitting ISCIB via the internet, the ISCIB can additionally include a header.

The ISCIB header can include block_type information, block_length information and/or protocol_version information.

The block_type information is an identifier identifying that a current block corresponds to the ISCIB.

The block_length information indicates the number of bytes remaining from a first byte to a last part of a block after the block_length information.

The protocol_version information indicates a protocol version. The protocol_version information can consist of 8 bits. An upper 4-bit indicates a major version number and a lower 4-bit indicates a minor version number.

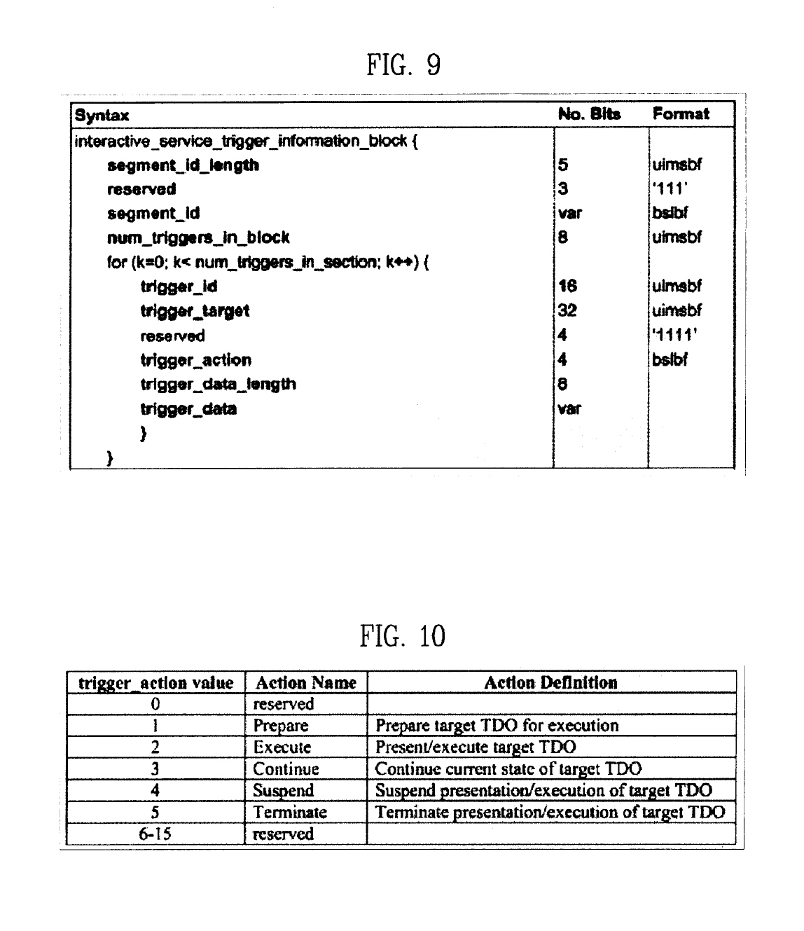

FIG. 9 is a diagram for a trigger information block according to one embodiment of the present invention.

The trigger information block may be called interactive_service_trigger_information_block (ISTIB).

The ISTIB forms basic building blocks for data on a trigger. Each of the blocks includes information on triggers used in an interactive service segment.

The ISTIB according to one embodiment of the present invention includes segment_id_length information, segment_id information, trigger_id information, trigger_target information, trigger_action information, target_data_length information, and/or target_data information.

The segment_id_length information indicates a length of the segment_id information.

The segment_id information identifies an interactive service segment to which a trigger information block (or ISTIB) is applied. The segment_id information can be defined as a form of a permitted URI to enable a user to which the segment_id information is assigned to use the segment_id information.

The trigger_id information is an identifier for a trigger in a segment identified by the segment_id information. Or, the trigger_id information may become an identifier identifying a trigger, which is included in a TDO. The trigger can be defined as an operation configured to generate a specific event in the TDO. Hence, the trigger_id information may be used as an identifier identifying an event in the TDO.

The trigger_target information is an identifier identifying a target TDO where a trigger is used. In an ISCIB including identical segment_id information, the trigger_target information is matched with content_linkage information including a value identical to the trigger_target information and may play a role of connecting the ISCIB to ISTIB.

The trigger_action information indicates a trigger action in a trigger operation time.

The target_data_length information indicates a length of the target_data information.

The target_data information includes data used by a target TDO.

In case that ISTIB is transmitted via a broadcast network, the ISTIB can be transmitted in a form of an interactive service trigger information table (IST-IT).

For an interactive service operating in a service-oriented mode, the IST-IT for an interactive service can include a plurality of IST-IT instances. Each of a plurality of the IST-IT instances includes time span information and ISTIB information for an interactive service segment during a period indicated by the time span information. Each of a plurality of the IST-IT instances can be identified by a start time of the time span.

For an interactive service operating in a segment-oriented mode, the IST-IT can consist of a single instance. The instance does not include information on a time span and does not include a time limit on ISTIB information included in the instance. In this case, the instance may include ISTIB for a current segment or ISTIB for at least one future segment.

Each of a plurality of the IST-IT instances can include at least one section. In case that the IST-IT is transmitted via a broadcast network, each section can be transmitted on a service signaling channel of a virtual channel including an interactive service related to broadcast contents.

If necessary, one ISTIB can be transmitted in a manner of being divided into a plurality of sections of an IST-IT instance. Each ISTIB may start at a start point of a section. If an ISTIB is transmitted in a manner of being divided into a plurality of sections, the ISTIB is divided into a plurality of ISTIB portions and each of the divided ISCIB may include information on each content item of an original ISCIB.

FIG. 10 is a diagram for a trigger action indicated by trigger_action information according to one embodiment of the present invention.

If a value of the trigger_action information is set to ‘0’, a trigger action is not currently defined and is reserved for a future use.

If a value of the trigger_action information is set to ‘1’, a trigger action corresponds to a ‘prepare’ state and it indicates a state that a target TDO is ready to be executed (or displayed).

If a value of the trigger_action information is set to ‘2’, a trigger action corresponds to an ‘execute’ state and it indicates a state that a target TDO should be executed (or displayed).

If a value of the trigger_action information is set to ‘3’, a trigger action corresponds to a ‘continue’ state and it indicates that a current state of a target TDO is continued.

If a value of the trigger_action information is set to ‘4’, a trigger action corresponds to a ‘suspend’ state and it indicates that appearance or execution of a target TDO should be suspended.

If a value of the trigger_action information is set to ‘5’, a trigger action corresponds to a ‘terminate’ state and it indicates that appearance or execution of a target TDO should be terminated.

The trigger_action information may have a value between ‘6’ and ‘15’. In this case, it indicates that a trigger action is not currently defined and is reserved for a future use.

A value different from the aforementioned value can be used for a value of the trigger_action information to indicate a trigger action.

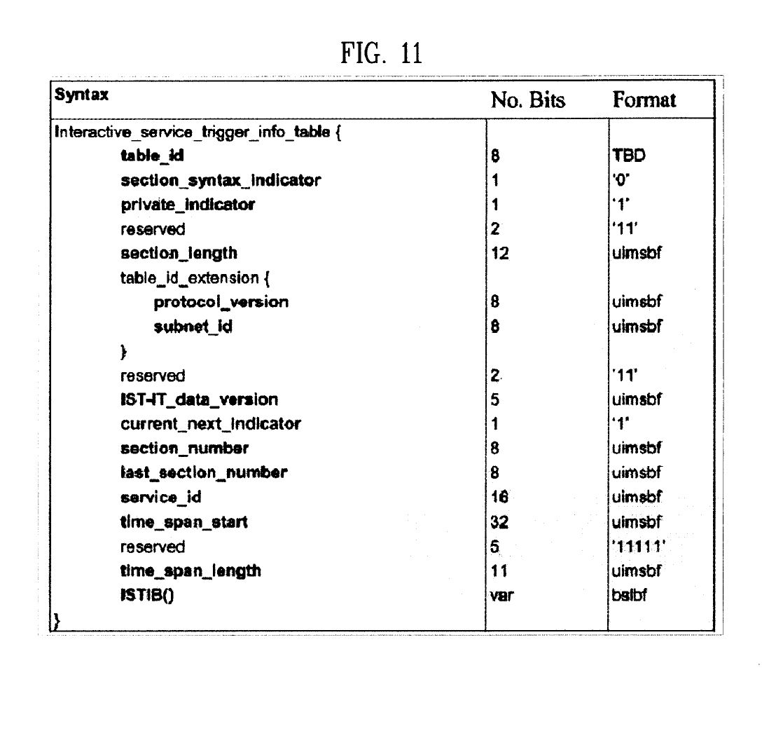

FIG. 11 is a diagram for an Interactive Service Trigger information Table (IST-IT) section according to one embodiment of the present invention.

The IST-IT section according to one embodiment of the present invention includes table_id information, protocol_version information, subnet_id information, IST_IT_data_version information, current_next_indicator information, section_number information, last_section_number information, service_id information, time_span_start information, time_span_length information, and/or ISTIB ( )

The table_id information is information for identifying that the IST-IT section belongs to the IST-IT.

The protocol_version information is information indicating a protocol version and can consist of 8 bits. An upper 4-bit indicates a major version number and a lower 4-bit may indicate a minor version number.

In case that the IST-IT is transmitted on a broadcast stream, the subnet_id information indicates an IP subnet related to a service signaling channel in which the IST-IT section is appeared. In case that the IST-IT is transmitted via the internet, the subnet_id information is set to a value identical to the value of the subnet_id information in the broadcast stream.

The IST_IT_data_version information indicates a version number of an IST-IT instance. Each of the IST-IT instances can be identified by a combination of values of the table_id information, the table_id_extension information, the service_id information and/or the time_span_start information.

The current_next_indicator information is information indicating that the IST-IT section is currently applied or will be applied in the future. As an example, a currently available ISC-IT can be always transmitted. In this case, this information can be always set to ‘1’.

The section_number information indicates a section number of an ISC-IT instance. The ISC-IT instance can be identified by a combination of values of the table_id information, the table_id_extension information, the service_id information, and the time_span_start information. The section_number information of a first section within the ISC-IT instance can be set to ‘0x00’ and a value of the section_number information may increase by ‘1’ on every additional section.

The last_section_number information indicates a section number of a last section of an ISC-IT instance.

The service_id information is a service identifier related to an interactive service providing the content item explained in the IST-IT instance.

The time_span_start information indicates a start of a time span covered by the IST-IT instance.

The time_span_length information indicates a length of a time span covered by the ISC-IT instance from a start time identified by the time_span_start information. Identical time_span_length information can be applied to each of a plurality of sections included in the IST-IT instance.

The ISCIB( ) information can include ISCIB data. Total of the ISTIB data for a segment or a part of the ISCIB, which includes information within a loop for the content item of the ISCIB only, can be included in the ISCIB( ) information.

In case that the ISTIB is transmitted via the internet for an interactive service, an ISTIB header can be transmitted in addition to the ISTIB.

The ISTIB header may have a form identical to that of the ISCIB header mentioned earlier in FIG. 8 and may have information playing an identical role of the information included in the ISCIB header. Hence, explanation on the ISTIB header is replaced by the explanation on the ISCIB header mentioned earlier in FIG. 8.

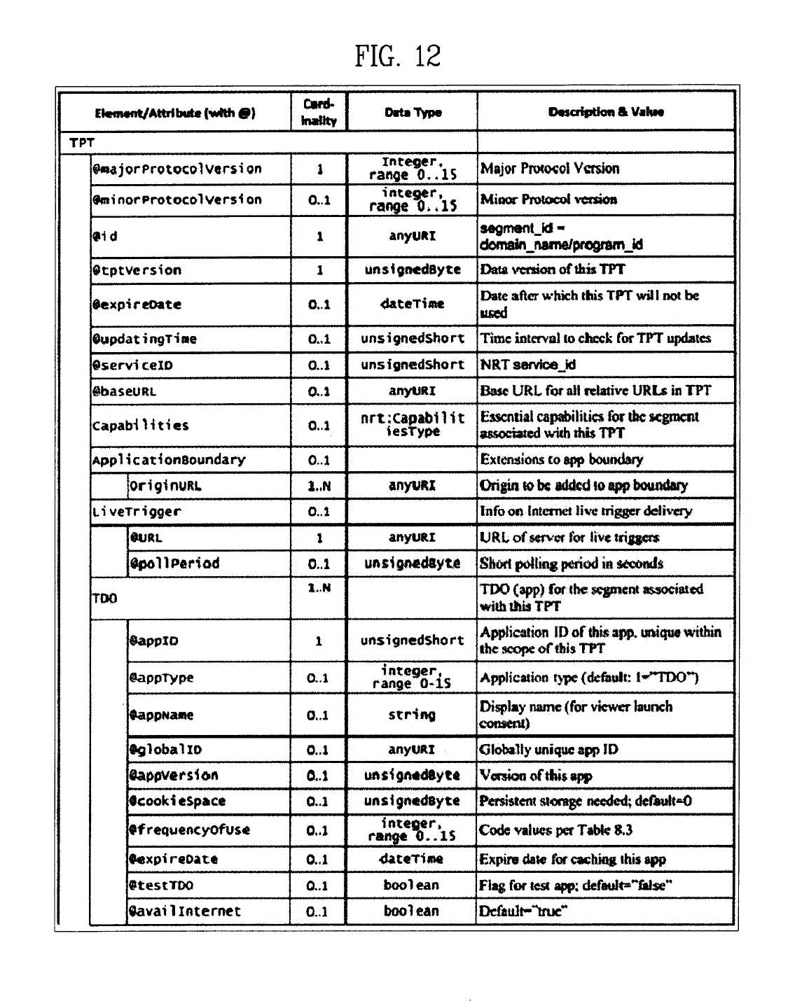

FIG. 12 is a diagram for a part of a TDO parameter table (TPT) according to one embodiment of the present invention.

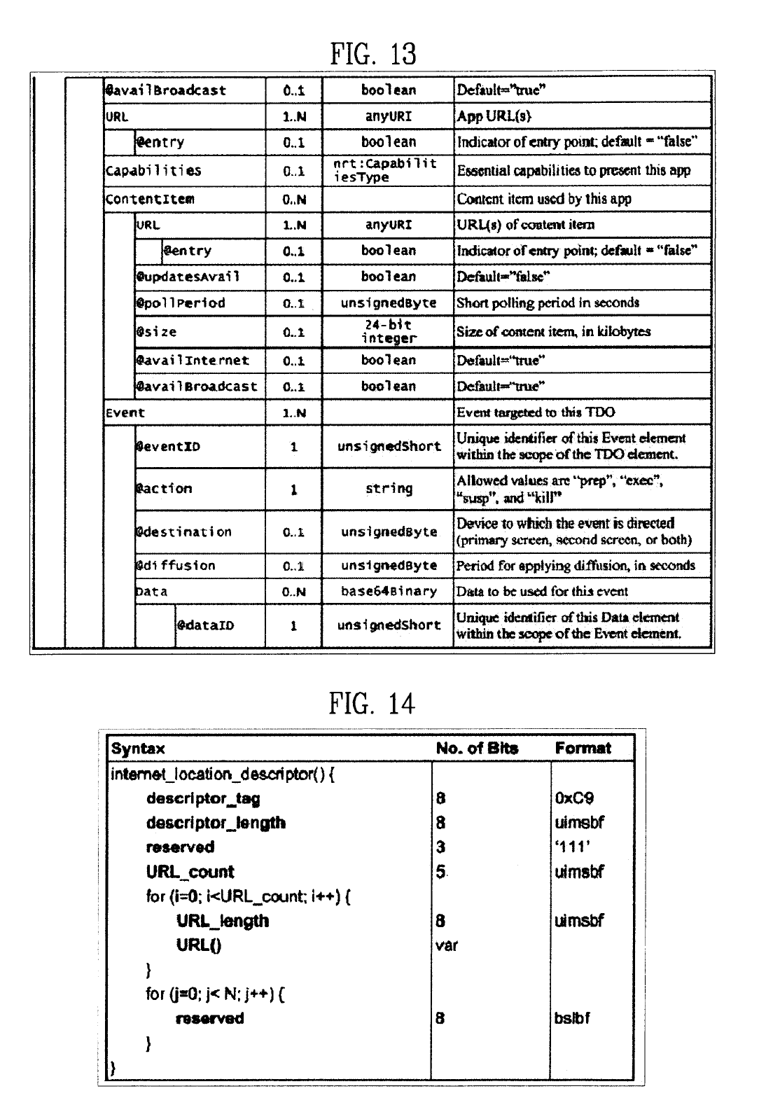

FIG. 13 is a diagram for a different part of a TDO parameter table (TPT) according to one embodiment of the present invention.

The TDO parameter table according to one embodiment of the present invention includes a segment and/or metadata on a TDO related to an event.

The TDO parameter table MajorProtocolVersion information, MinorprotocolVersion information, id information, tptVersion information, expireDate information, updatingTime information, serviceID information, base_URL information, Capabilities information, ApplicationBoundary information, OriginURL information, LiveTrigger information, URL information, pollPeriod information, TDO information, appID information, appType information, appName information, globalID information, app Version information, cookieSpace information, frequencyOfUse information, expireDate information, testTDO information, availInternet information, availBroadcast information, URL information, entry information, Capabilities information, ContentItem information, URL information, entry information, updatesAvail information, pollPeriod information, Size information, availInternet information, availBroadcast information, Event information, eventID information, action information, destination information, diffusion information, Data information, and/or dataID information.

The MajorProtocolVersion indicates a major version number of a table definition. A receiver can discard a TPT having a major version number incapable of being supported by the receiver.

The MinorProtocolVersion information indicates a minor version number of a table definition. A receiver does not discard a TPT having a minor version number incapable of being supported by the receiver. In this case, the receiver processes the TPT in a manner of ignoring information or an element not supported by the receiver.

The id information identifies an interactive programming segment (or interactive service segment) related to the TPT.

The tptVersion information indicates version information of a TPT.

The expireDate information indicates an expiration date and time of information included in a TPT instance. If a receiver stores a TPT, the TPT can be reused until the data and time indicated by the expireDate information.

When a TPT is needed to be modified, the updatingTime information indicates a recommended interval to download a TPT and to execute an operation of checking whether the newly downloaded TPT corresponds to a TPT of a new version.

The serviceID information indicates an identifier of an NRT service related to an interactive service explained in a TPT instance.

The base_URL information indicates a base URL capable of being used in a manner of combining with a front end of a related URL appeared in a TPT. The base_URL information indicates an absolute URL of files.

The Capabilities information indicates an essential capability necessary to express an interactive service related to a TPT.

The ApplicationBoundary information includes information on an origin, which is added to an application boundary of a TDO.

The OriginURL information indicates an origin, which is added to an application boundary of a TDO, in a URL form.

The LiveTrigger information includes information used in case that an activation trigger is provided via the internet. The LiveTrigger information provides information necessary for a receiver to obtain an activation trigger.

The URL information indicates a URL of a server transmitting an activation trigger via the internet.

If there exists the pollPeriod information, it indicates that a short polling is used to transmit an action trigger. The pollPeriod information indicates a polling period.

The TDO information includes information on an application (e.g., TDO) providing a part of an interactive service during a segment explained by a TPT instance.

The appID information identifies an application (e.g., TDO) within a range of a TPT. An activation trigger identifies a target application using the appID information to apply a trigger.

The appType information identifies a format type of an application. For instance, if a value of the appType information is set to ‘1’, it may indicate that an application corresponds to a TDO.

The appName information indicates a name of a readable application displayed for a viewer.

The globalID information indicates a global identifier of an application. If there exists the globalID information, a receiver stores an application code and may reuse the application code to express an identical application in a future segment of an identical or a different broadcasting company.

The appVersion information indicates a version number of an application.

The cookieSpace information indicates a size of a space necessary for an application to consistently store data between application calls.

The frequencyOfUse information indicates an approximate frequency on how often an application is used in a broadcast. For instance, the frequencyOfUse information can indicate that an application is repeatedly used in time unit, date unit, week unit, or month unit. Or, the frequencyOfUse information can indicate that an application is used one time only.

The expireDate information indicates a time and date that a receiver can safely delete an application and/or related resources.

The testTDO information indicates whether an application is used for a test purpose.

The availInternet information indicates whether an application is downloadable via the internet.

The availBroadcast information indicates whether an application can be extracted from a broadcast signal.

The URL information identifies a file corresponding to a part of an application.

The entry information indicates whether a file identified by the URL information corresponds to a file executed to execute an application.

The Capabilities information indicates capabilities of a receiver necessary to perform a meaningful expression of an application.

The ContentItem information includes information on content item consisted of one or more files required by an application.

The URL information identifies a file corresponding to a part of a content item.

The entry information indicates whether a file is executable to execute a content item.

The updatesAvail information indicates whether a content item is occasionally updated.

If there exists the pollPeriod information, it indicates that a short polling is used to transmit an activation trigger. The pollPeriod information indicates a time used by a receiver with a polling period.

The Size information indicates a size of a content item.

The availInternet information indicates whether a content item is downloadable via the internet.

The availBroadcast information indicates whether a content item can be extracted from a broadcast signal.

The Event information includes information on an event for a TDO application.

The eventID information plays a role of identifying an event within a range of a TDO application. An activation trigger can be identified by a combination of a target application to which a trigger is applied, the appID information, and the eventID information.

The action information indicates a type of an action, which should be applied when an event operates. For instance, the action information can be used as information similar to the trigger_action information mentioned earlier in FIG. 10.

The destination information indicates a type of a target device for an event. For instance, the destination information can indicate that a corresponding event should be executed in a primary device or a secondary device according to a value of the destination information. Or, the destination information can indicate that the corresponding event should be executed in the primary device and/or the secondary device according to the value of the destination information.

The diffusion information indicates a parameter to smooth a peak of a server loading. The diffusion information can indicate a period T in second unit. A receiver calculates a random time within a range from 0 to T second and may be able to delay time as much as the calculated time to obtain the content referred by URLs of a TPT before accessing an internet server.

The Data information includes information on data related to an event.

The dataID information plays a role of identifying data in an event. If there exists data related to an operation of the event, an activation trigger identifies a related data by a combination of the appID information, the eventID information, and the dataID information.

According to one embodiment of the present invention, the aforementioned ISCIB and the ISTIB can be signaled as a TPT structure in a manner of being integrated to each other.

FIG. 14 is a diagram for internet_location_descriptor according to one embodiment of the present invention.

The internet_location_descriptor according to one embodiment of the present invention can include descriptor_tag information, descriptor_length information, URL_count information, URL_length information, and/or URL( ) information.

The descriptor_tag information is information identifying a descriptor and indicates that this descriptor corresponds to internet_location_descriptor.

The descriptor_length information indicates a length of data included in this descriptor after the descriptor_length information.

The URL_count information indicates the number of informations related to URL referred by this descriptor.

The URL_length information indicates a length of the URL( ) information.

The URL( ) information includes text string information indicating a URL.

The internet_location_descriptor can be transmitted via a region in which descriptors of the aforementioned ISCIB, ISTIB, ISC-IT, IST-IT, and/or TPT can be included.

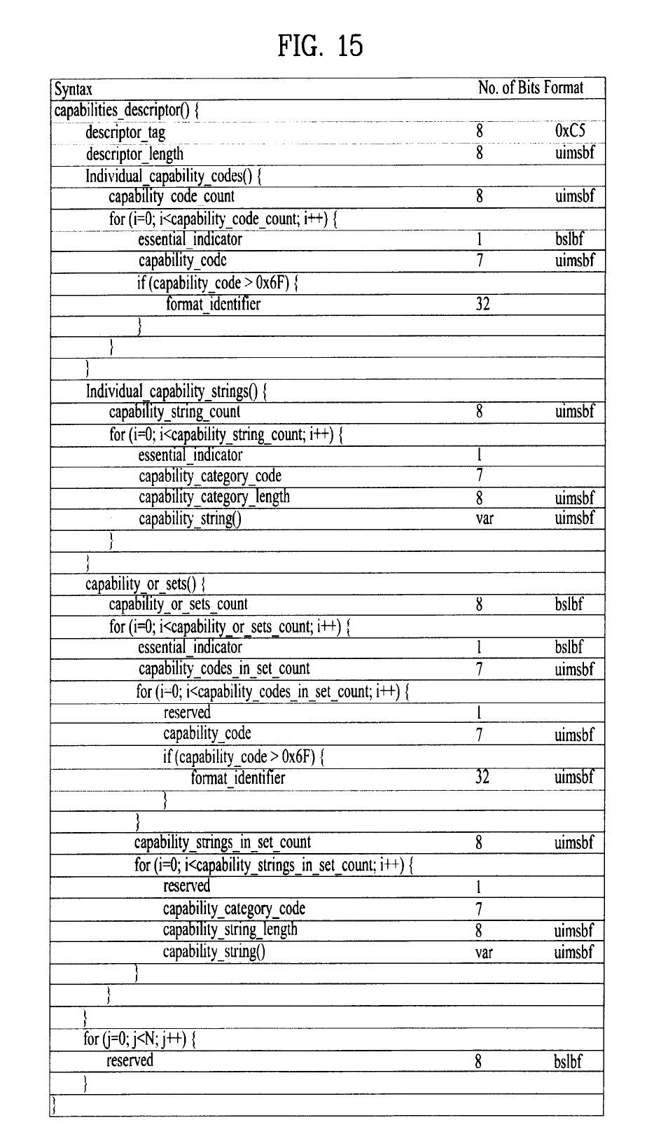

FIG. 15 is a diagram for capabilities_descriptor according to one embodiment of the present invention.

The capabilities_descriptor according to one embodiment of the present invention includes descriptor_tag information, descriptor_length information, capability_code_count information, essential_indicator information, capability_code information, format_identifier information, capability_string_count information, essential_indicator information, capability_category_code information, capability_string_length information, capability_string( ) information, capability_or_set_count information, essential_indicator information, capability_codes_in_set_count information, capability_category_code information, format_identifier information, capability_strings_in_set_count information, capability_category_code information, capability_string_length information, and/or capability_string( ) information.

The descriptor_tag information is information indicating that this descriptor corresponds to the capabilities_descriptor.

The descriptor_length information indicates a length of data included in this descriptor after the descriptor_length information.

The capability_code_count information indicates the number of capability_code informations.

The essential_indicator information indicates whether a support of a capability identified by the capability_code information is essential to perform a meaningful expression of an interactive service or a content item.

The capability_code information is information identifying a specific capability. For instance, the capability_code information can be used to identify a capability on a download protocol, FEC algorithm, Wrapper/Archive format, compression algorithm, and a media type according to a value of the capability_code information. For instance, the capability_code information can indicates that FLUTE protocol is used for the download protocol. For instance, the capability_code information can indicates that FEC scheme is not used for the FEC algorithm and Raptor algorithm is used instead. For instance, the capability_code information can indicates that DEFLATE algorithm is used for the compression algorithm. For instance, the capability_code information can indicates that the media type corresponds to HE AAC v2 to which an AVC normal definition video, an AVC high definition video, an AC-3 audio, an E-AC-3 audio, an MP3 audio, an AVC mobile video, HE AAC v2 mobile audio, HE AAC v2 level 4 audio, a DTS-HD audio, a CFF-TF, a CEA-708 caption, and/or MPEG surround are applied.

The format_identifier information is identical to the content defined for a registration_descriptor( ) in a section 2.6.9 of ISO/IEC 13818-1.

The capability_string_count information indicates the number of the capability_string( ) informations.

The essential_indicator information indicates whether a support of a capability supported by information on a capability string, which follows the essential_indicator information, is essential to perform a meaningful expression of an interactive service or a content item.

The capability_category_code information indicates a capability category for a value of a string, which follows the capability_category_code information. For instance, the capability_category_code information can indicate a capability category for a download protocol, FEC algorithm, Wrapper/Archive format, compression algorithm, and a media type.

The capability_string_length information indicates a length of the capability_string( ) information.

The capability_string( ) information includes information on a capability. The capability_string( ) information includes information on the capability of the category identified by the capability_category_code information.

The capability_or_set_count information indicates the number of capabilities ‘OR set’.

The essential_indicator information indicates whether a support of a capability supported by the capability ‘OR set’, which follows the essential_indicator information, is essential to perform a meaningful expression of an interactive service or a content item.

The capability_codes_in_set_count information indicates the number of the capability_code informations within a capability set.

The capability_code information is information identifying a specific capability. For instance, the capability_code information can be used to identify a capability on a download protocol, FEC algorithm, Wrapper/Archive format, compression algorithm, and a media type according to a value of the capability_code information. For instance, the capability_code information can indicates that FLUTE protocol is used for the download protocol. For instance, the capability_code information can indicates that FEC scheme is not used for the FEC algorithm and Raptor algorithm is used instead. For instance, the capability_code information can indicates that DEFLATE algorithm is used for the compression algorithm. For instance, the capability_code information can indicates that the media type corresponds to HE AAC v2 to which an AVC normal definition video, an AVC high definition video, an AC-3 audio, an E-AC-3 audio, an MP3 audio, an AVC mobile video, HE AAC v2 mobile audio, HE AAC v2 level 4 audio, a DTS-HD audio, a CFF-TF, a CEA-708 caption, and/or MPEG surround are applied.

The format_identifier information is identical to the content defined for a registration_descriptor( ) in a section 2.6.9 of ISO/IEC 13818-1.

The capability_strings_in_set_count information indicates the number of the capability_string informations within a capability set.

The capability_category_code information indicates a capability category for a value of a string, which follows the capability_category_code information. For instance, the capability_category_code information can indicate a capability category for a download protocol, FEC algorithm, Wrapper/Archive format, compression algorithm, and a media type.

The capability_string_length information indicates a length of the capability_string( ) information, which follows the capability_string_length information.

The capability_string( ) information includes information on a capability. The capability_string( ) information includes information on the capability of the category identified by the capability_category_code information.

The capabilities_descriptor can be transmitted via a region in which descriptors of the aforementioned ISCIB, ISTIB, ISC-IT, IST-IT, and/or TPT can be included.

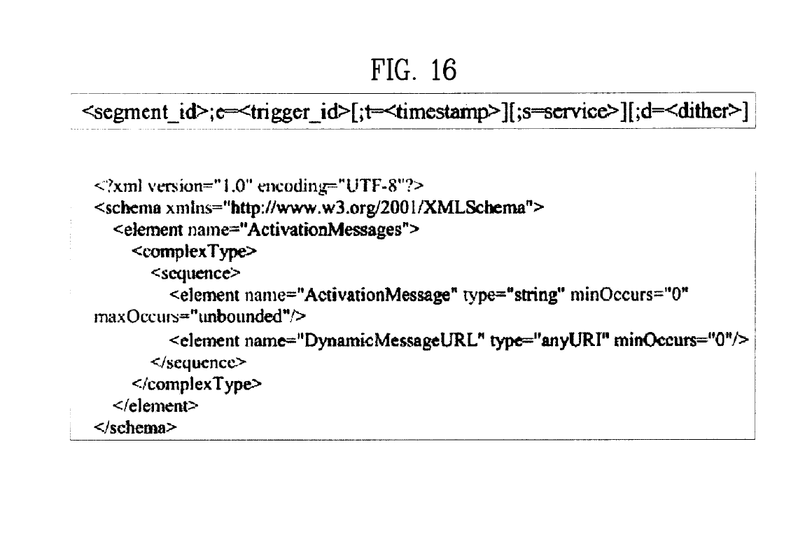

FIG. 16 is a diagram for an activation message according to one embodiment of the present invention.

The activation message can be defined by an XML form or a string form. The activation message can be called an activation trigger as well.

The activation message can include segment_id information, trigger_id information, timestamp information, service information, and/or dither information.

The segment_id information identifies an interactive service segment including a trigger, which is to be operated by the activation message. In case of the segment-oriented mode, the segment_id information may identify a time base, which is to be used as a reference for the timestamp information.

The trigger_id information identifies a trigger, which is to be operated. The trigger_id information can be used to identify the trigger together with the segment_id information. Or, the trigger_id information may become an identifier identifying a trigger included in a TDO. The trigger can be defined as an operation configured to generate a specific event in the TDO. Hence, the trigger_id information can be used as an identifier identifying an event within the TDO.

If there exist timestamp information, the timestamp information can identify a time on which a trigger should operate. If there does not exist the timestamp information, the trigger can operate as soon as the activation message arrives.

The service information indicates a service_id of an interactive service including a trigger, which should be operated by an activation message. The service_id is an identifier identifying a service. The service information can be defined in case that a virtual channel includes at least one interactive service.

The dither information indicates a time interval configured to disperse a query for a server to disperse a workload of the server.

If an activation message is transmitted via a broadcast network, the activation message can be transmitted via a closed caption region of a video header.

If an activation message is transmitted via the internet, there may exist messages of two types, i.e., a static activation message and a dynamic activation message. The static activation message is the activation message in case that an activation time is known before a specific time. On the contrary, the dynamic activation message is the activation message in case that an activation time is not known before a specific time.

An activation message referring to a trigger within the ISTIB can be transmitted in an XML form. A string value of an Activation Message element within the activation message, which is transmitted in the XML form, corresponds to the static activation message, which refers to the trigger within the ISTIB. A DynamicMessageURl element can exist in case that there exists a dynamic activation message for an interactive service segment to which the ISTIB belongs. In this case, a URL of a source for the dynamic activation message can be configured as a value of the DynamicMessageURl element.

Activation message files can be transmitted via HTTP according to a query protocol. The dynamic activation message can be transmitted by an HTTP streaming.

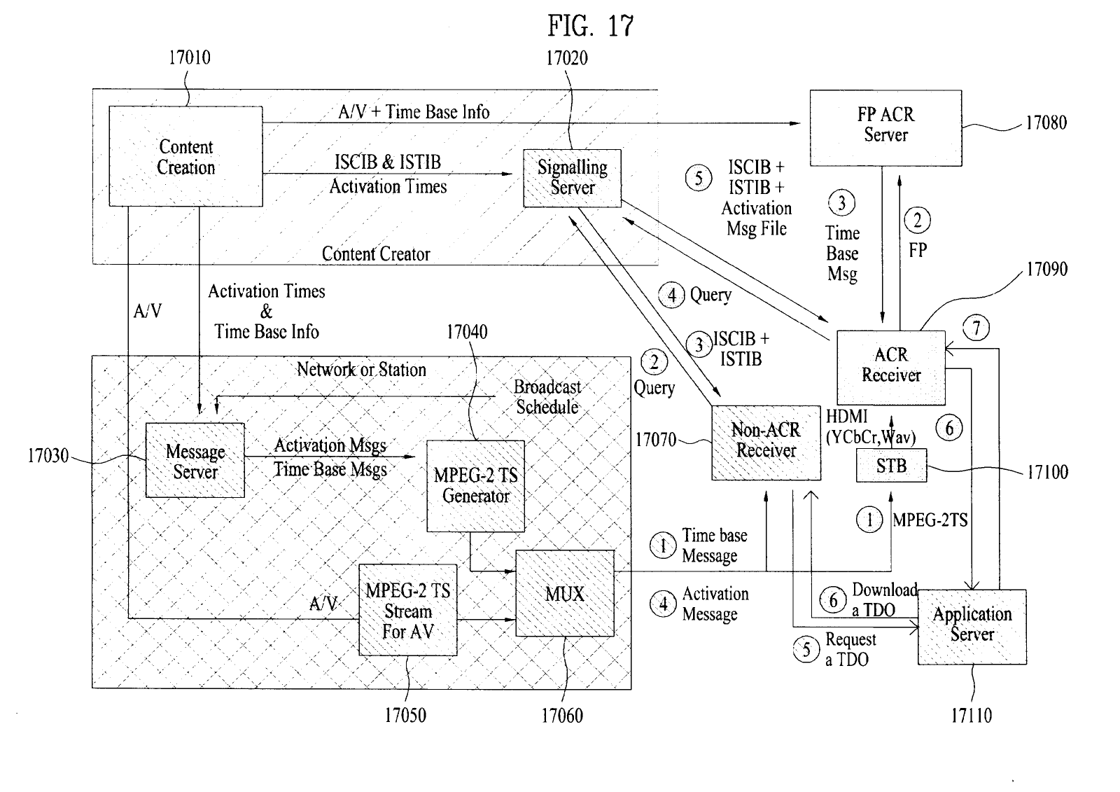

FIG. 17 is a diagram for a broadcast system transmitting a time base message and/or an activation message on an ES in a segment-oriented mode according to one embodiment of the present invention.

The broadcast system according to one embodiment of the present invention includes a content creation device 17010, a signaling server 17020, a message server 17030, an MPEG-2 TS generator 17040, an MPEG-2 TS AV stream processing unit 17050, a multiplexing unit 17060, a non-ACR receiver 17070, an ACR server 17080, an ACR receiver 17090, a set-top box 17100, and/or an application server 17110.

The content creation device 17010 is a device or a server configured to disseminate content. The content creation device creates and transmits a program image and a caption. And, the content creation device 17010 creates and transmits data including signaling information on an interactive service. The data includes the aforementioned ISCIB, ISTIB, time base information, activation time information, and/or informations included thereof. The content creation device 17010 can provide both a produced stream used for a broadcast program and a data for an interactive service together. The data for the interactive service can include the aforementioned time base message and the activation message. Both the two messages may include the information positioned at the ISCIB and the ISTIB.

The signaling server 17020 plays a role of storing the ISCIB, the ISTIB, the activation time information, and/or information included thereof and providing them to a receiver.

The message server 17030 receives the activation time information and generates an activation message. The message server 17030 receives time base information and generates a time base message. The message server 17030 can additionally receive broadcast schedule information from a broadcasting company.

The MPEG-2 TS generator 17040 generates an MPEG-2 TS (transport stream) including the activation message and/or the time base message.

The MPEG-2 TS AV stream processing unit 17050 generates an MPEG-2 TS including a broadcast AV.

The multiplexing unit 17060 multiplexes the MPEG-2 TS (transport stream) including the activation message and/or the time base message and the MPEG-2 TS including the broadcast AV.

The non-ACR receiver 17070 indicates a receiver directly receiving a ground wave broadcast signal. The non-ACR receiver 17070 may or may not include an ACR (automatic content recognition) function. If the ACR function is included in the non-ACR receiver 17070 and the internet connection is established, the non-ACR receiver may operate similar to the ACR receiver.

In case of an ACR, the ACR server 17080 is a server providing trigger-related information of an interactive service. The ACR server 17080 can receive/store AV data and/or a time base message and transmits the corresponding time base message to the ACR receiver in accordance with an ACR result.

The ACR receiver 17090 cannot directly receive a ground wave broadcast signal. The ACR receiver indicates a receiver depending on a decoding function of such a reception auxiliary device to receive a cable and satellite broadcasting as a set-top box. Or, the ACR receiver 17090 indicates a receiver receiving such a raw data as an external input (e.g., YCbCr and Way) as a digital or analog although the receiver has a function of directly receiving a ground wave broadcast signal.

The set-top box 17100 is a device configured to receive a cable or a satellite broadcast signal and provide the signal to a receiver in a manner of decoding the signal.

The application server 17110 is a server providing an application related to broadcast content. The application may include a TDO.

The time base message and/or the activation message can be transmitted or received via a broadcast network. In this case, the time base message and/or the activation message can be transmitted or received by a DTV-CC (closed caption) or a packetized elementary stream (PES).

If a message and/or the activation message are transmitted or received on the PES, the non-ACR receiver 17070 receives the time base message on the PES. The non-ACR receiver 17070 makes a request for ISCIB, ISTIB, and/or information thereof to the signaling server 17020 and receives them. The non-ACR receiver 17070 waits until the activation message is received from the PES. The non-ACR receiver 17070 parses segment_id information, trigger_id information and/or service_id information from the ISCIB, the ISTIB, and/or the information thereof. The non-ACR receiver 17070 receives a TDO from the application server 17110 and performs an operation indicated by the information of the ISTIB on a time indicated by the timestamp information of the activation message.

Meanwhile, the ACR receiver 17090 extracts a finger print or a watermark identifying corresponding content from an AV frame. The ACR receiver 17090 transmits the extracted finger print or the watermark to the ACR server 17080 and receives a time base message on the content identified by the finger print or the watermark from the ACR server 17080. The ACR receiver 17090 makes request for ISCIB, ISTIB, an activation message and/or information thereof to the signaling server 17020 identified by the time base message and receives them. The ACR receiver 17090 extracts segment_id information, trigger_id information, and service_id information from the ISCIB and/or the ISTIB. The ACR receiver 17090 downloads a TDO from the application server 17110. The ACR receiver 17090 performs an appropriate operation indicated by the information of the ISTIB on a time indicated by the timestamp information of the activation message.

The activation message and/or the time base message can be transmitted or received via the internet network. Or, the activation message and/or the time base message can be transmitted or received by a single binary format or an XML format.

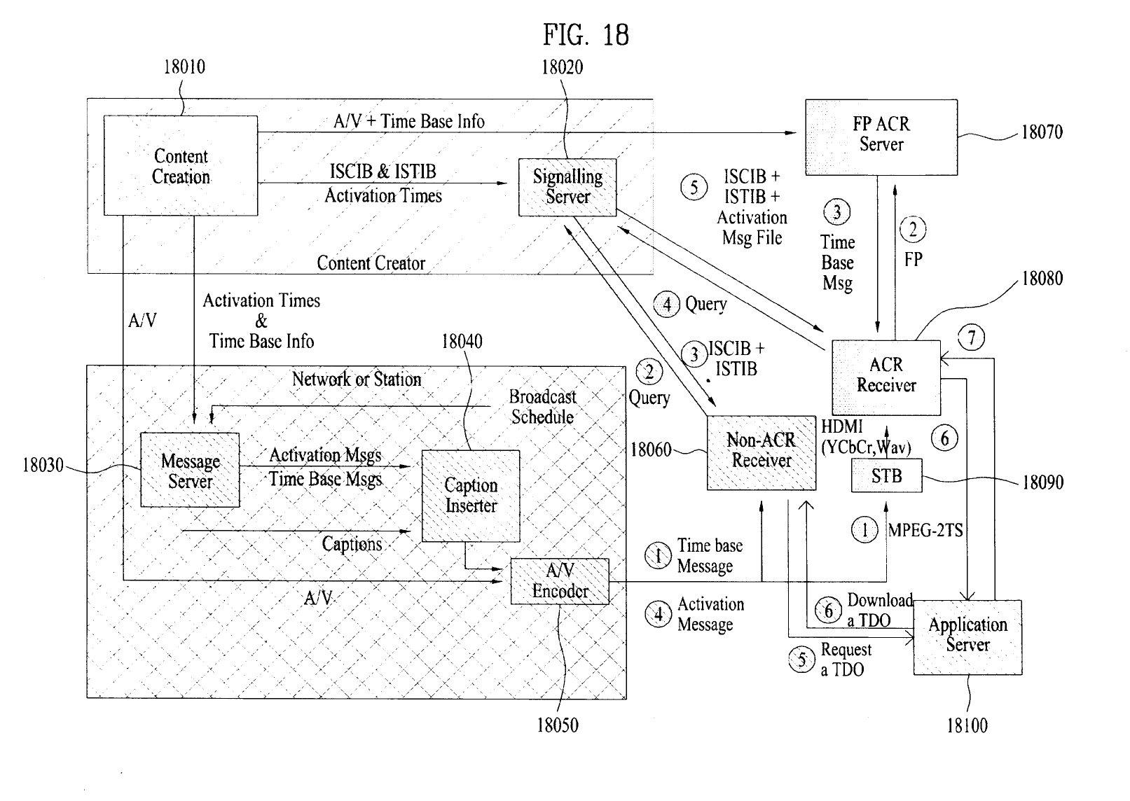

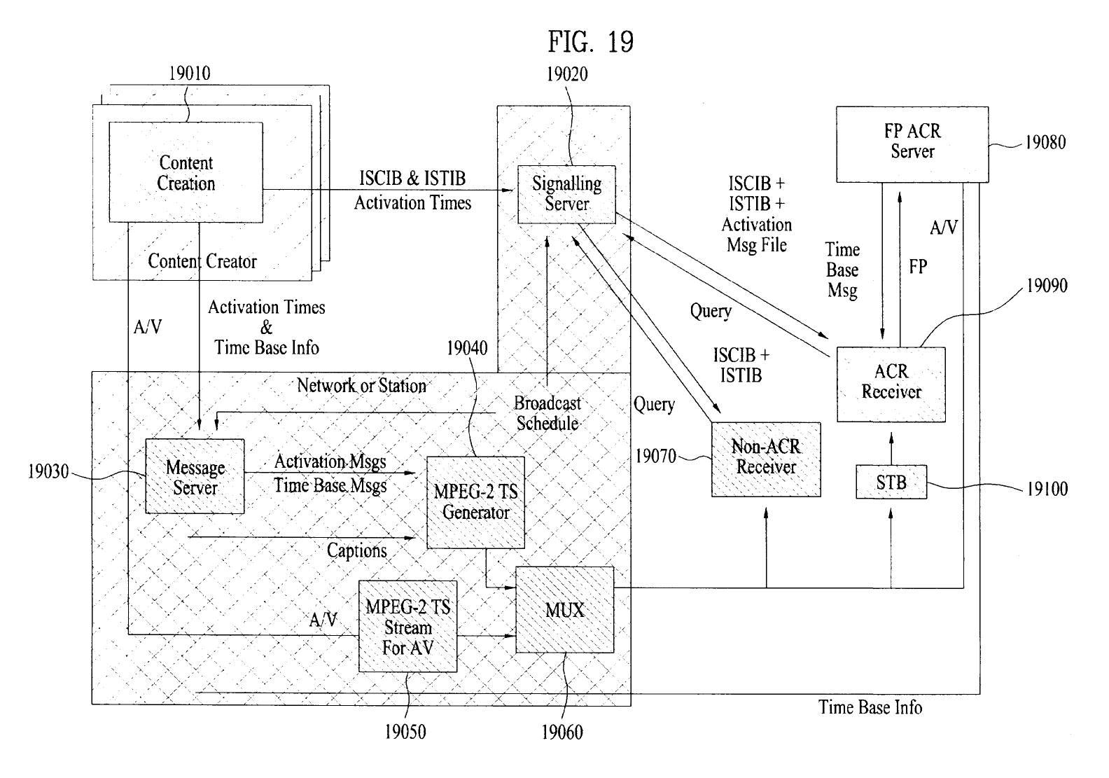

FIG. 18 is a diagram for a broadcast system transmitting a time base message and/or an activation message on a DTV-CC in a segment-oriented mode according to one embodiment of the present invention.

The broadcast system according to one embodiment of the present invention includes a content creation device 18010, a signaling server 18020, a message server 18030, a caption inserter 18040, an AV encoder 18050, a non-ACR receiver 18060, an ACR server 18070, an ACR receiver 18080, a set-top box 18090, and/or an application server 18100.

Explanation on a block including an identical name mentioned earlier in FIG. 17 is replaced by the explanation on FIG. 17.

The caption inserter 18040 receives an activation message and/or a time base message and additionally receives a caption. And then, the caption inserter inserts the activation message and/or the time base message into the caption. The AV encoder 18050 generates a broadcast stream using the caption including the activation message and/or the time base message and an AV data.

If a message and/or the activation message are transmitted or received via a DTV-CC, the non-ACR receiver 18060 receives the time base message on the DTV-CC. The non-ACR receiver 18060 makes a request for ISCIB, ISTIB, and/or information thereof to the signaling server 18020 and receives them. The non-ACR receiver 18060 waits until the activation message is received from the DTV-CC. The non-ACR receiver 18060 parses segment_id information, trigger_id information and/or service_id information from the ISCIB, the ISTIB, and/or the information thereof. The non-ACR receiver 18060 receives a TDO from the application server 18100 and performs an operation indicated by the information of the ISTIB on a time indicated by the timestamp information of the activation message.

Meanwhile, the ACR receiver 18080 extracts a finger print or a watermark identifying corresponding content from an AV frame. The ACR receiver 18080 transmits the extracted finger print or the watermark to the ACR server 18070 and receives a time base message on the content identified by the finger print or the watermark from the ACR server 18070. The ACR receiver 18080 makes request for ISCIB, ISTIB, an activation message and/or information thereof to the signaling server 18020 identified by the time base message and receives them. The ACR receiver 18080 extracts segment_id information, trigger_id information, and service_id information from the ISCIB and/or the ISTIB. The ACR receiver 18080 downloads a TDO from the application server 18100. The ACR receiver 18080 performs an appropriate operation indicated by the information of the ISTIB on a time indicated by the timestamp information of the activation message.

The activation message and/or the time base message can be transmitted or received via the internet network. Or, the activation message and/or the time base message can be transmitted or received by a single binary format or an XML format.

FIG. 19 is a diagram for a broadcast system transmitting a time base message and/or an activation message on a PES in a service-oriented mode according to one embodiment of the present invention.

The broadcast system according to one embodiment of the present invention includes a content creation device 19010, a signaling server 19020, a message server 19030, an MPEG-2 TS generator 19040, an MPEG-2 TS AV stream processing unit 19050, a multiplexing unit 19060, a non-ACR receiver 19070, an ACR server 19080, an ACR receiver 19090, and/or a set-top box 19100.

The content creation device 19010 is a device or a server configured to disseminate content. The content creation device creates and transmits a program image and a caption. And, the content creation device 19010 creates and transmits data including signaling information on an interactive service. The data includes the aforementioned ISCIB, ISTIB, time base information, activation time information, and/or informations included thereof. The content creation device 19010 can provide both a produced stream used for a broadcast program and a data for an interactive service together. The data for the interactive service can include the aforementioned time base message and the activation message. Both the two messages may include the information positioned at the ISCIB and the ISTIB.

The signaling server 19020 plays a role of storing the ISCIB, the ISTIB, the activation time information, and/or information included thereof and providing them to a receiver. The signaling server 19020 receives a broadcasting schedule and can store ISCIB, ISTIB, and/or activation time in a manner of modifying the ISCIB, the ISTIB, and/or the activation time in accordance with the broadcasting schedule.

The message server 17030 receives the activation time information and generates an activation message. The message server 17030 receives time base information and generates a time base message. The message server 17030 can additionally receive broadcast schedule information from a broadcasting company. The message server 19030 receives a broadcasting schedule and can modify ISCIB, ISTIB, and/or activation time according to the broadcasting schedule. The message server 19030 transmits the generated time base message to the ACR server 19080 with or without modifying the time base message.

The MPEG-2 TS generator 19040 generates an MPEG-2 TS (transport stream) including the activation message and/or the time base message.

The MPEG-2 TS AV stream processing unit 19050 generates an MPEG-2 TS including a broadcast AV.

The multiplexing unit 19060 multiplexes the MPEG-2 TS (transport stream) including the activation message and/or the time base message and the MPEG-2 TS including the broadcast AV.

The non-ACR receiver 19070 indicates a receiver directly receiving a ground wave broadcast signal. The non-ACR receiver 19070 may or may not include an ACR (automatic content recognition) function. If the ACR function is included in the non-ACR receiver 17070 and the internet connection is established, the non-ACR receiver may operate similar to the ACR receiver.

In case of an ACR, the ACR server 19080 is a server providing trigger-related information of an interactive service. The ACR server 19080 can store a time base message and transmits the corresponding time base message to the ACR receiver in accordance with an ACR result.

The ACR receiver 19090 cannot directly receive a ground wave broadcast signal. The ACR receiver indicates a receiver depending on a decoding function of such a reception auxiliary device to receive a cable and satellite broadcasting as a set-top box. Or, the ACR receiver 19090 indicates a receiver receiving such a raw data as an external input (e.g., YCbCr and Way) as a digital or analog although the receiver has a function of directly receiving a ground wave broadcast signal.

The set-top box 19100 is a device configured to receive a cable or a satellite broadcast signal and provide the signal to a receiver in a manner of decoding the signal.

In case of the service-oriented mode, as mentioned in the foregoing description, an operation of the non-ACR receiver 19070 is similar to the operation of the ACR receiver 19090. Yet, information of the time base message and/or the activation message, which is transmitted to the signaling server 19020 and the MPEG-2 TS generator 19040, can be freely controlled by a broadcasting company or a broadcasting system when the information is disseminated.

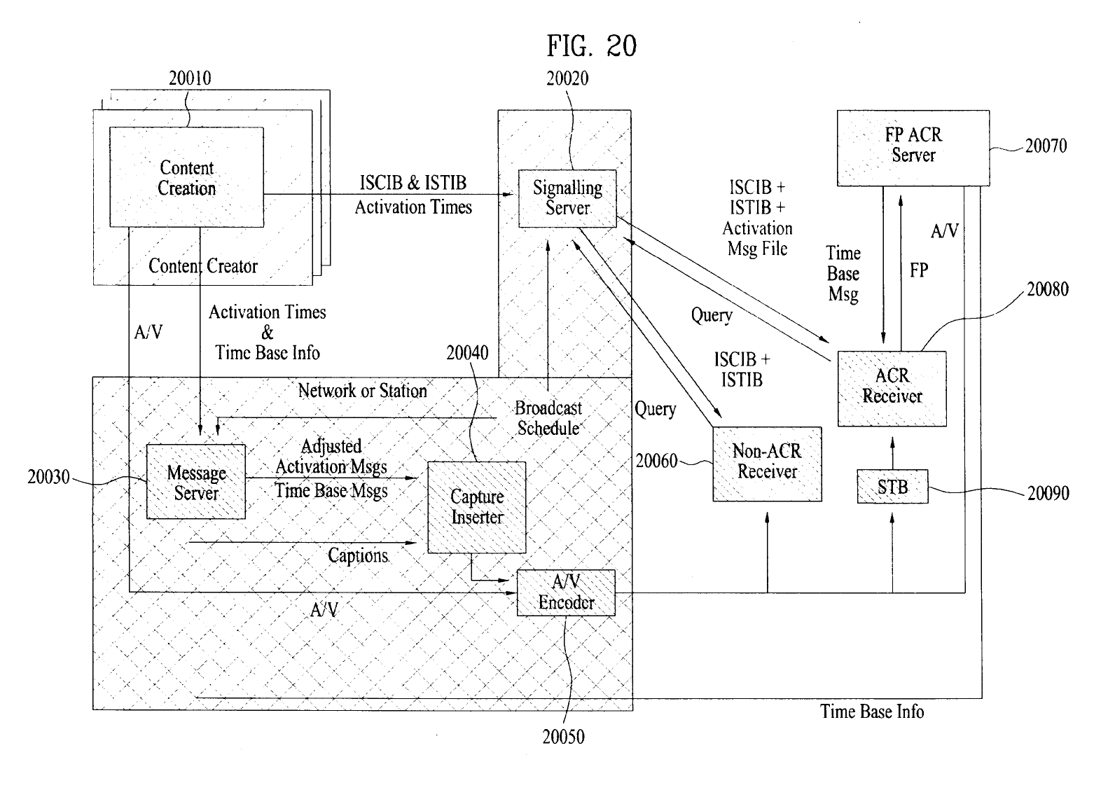

FIG. 20 is a diagram for a broadcast system transmitting a time base message and/or an activation message on a DTV-CC in a service-oriented mode according to one embodiment of the present invention.

The broadcast system according to one embodiment of the present invention includes a content creation device 20010, a signaling server 20020, a message server 20030, a caption inserter 20040, an AV encoder 20050, a non-ACR receiver 20060, an ACR server 20070, an ACR receiver 20080, and/or a set-top box 20090.

Explanation on a block including an identical name mentioned earlier in FIG. 19 is replaced by the explanation on FIG. 17.

The caption inserter 20040 receives an activation message and/or a time base message and additionally receives a caption. And then, the caption inserter inserts the activation message and/or the time base message into the caption. The AV encoder 20050 generates a broadcast stream using the caption including the activation message and/or the time base message and an AV data.

In case of the service-oriented mode, as mentioned in the foregoing description, an operation of the non-ACR receiver 20060 is similar to the operation of the ACR receiver 20080. Yet, information of the time base message and/or the activation message, which is transmitted to the signaling server 20020 and the message server 20030, can be freely controlled by a broadcasting company or a broadcasting system when the information is disseminated.

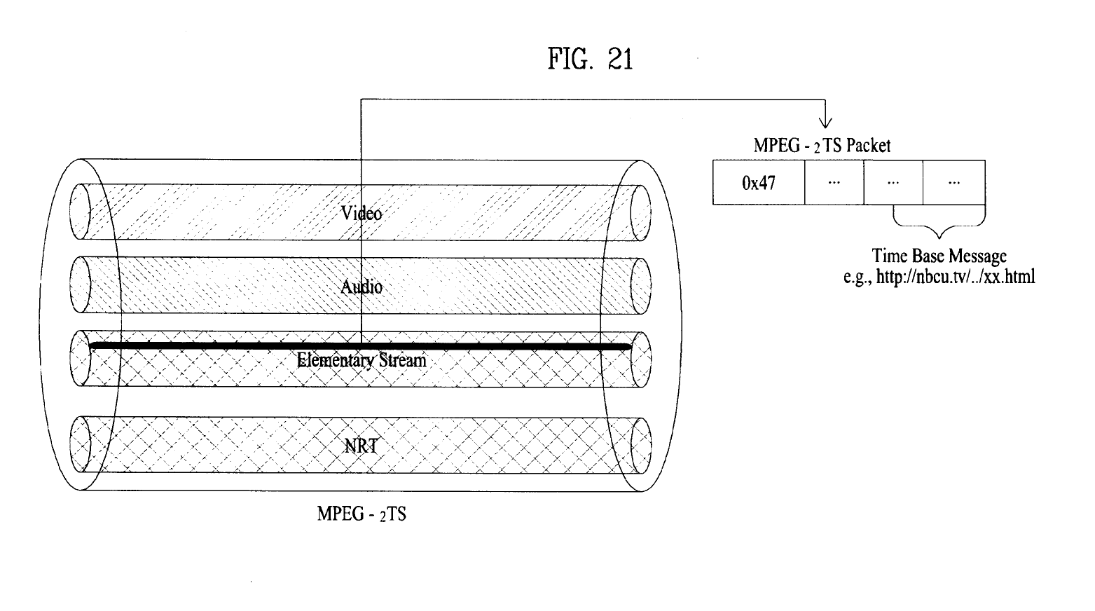

FIG. 21 is a diagram for MPEG2-TS transmitting a time base message according to one embodiment of the present invention.

As mentioned in the foregoing description, the time base message can include URL information, mode information, timestamp information, service_id information, and/or dither information. Each of the informations can be reconfigured in a prescribed form to be transmitted. As an example, as mentioned in the foregoing description, the informations can be configured in a single URL form.

The time base message can be transmitted by at least one scheme. One of the transmission schemes is to transmit the time base message on MPEG-2 TS elementary stream (ES). Another transmission scheme is to transmit the time base message via a caption region according to a DTV-CC or to transmit the time base message via the internet. Regarding this, it shall be described later. No matter what transmission scheme is used, content of information data or its role is similar to each other while each form of the transmission schemes is modified only.

In case of transmitting the time base message on the MPEG-2 TS elementary stream (or synchronized ES or PES), as depicted in FIG. 21, data of the time base message is transmitted in a manner of being included in the ES.

The data of the time base message can be transmitted in a manner of being configured by a form of a data section. In this case, the data of the data section form can be transmitted in a manner of being included in an ES loop of an EIT (event information table) and/or a table according to a PSIP (program and system information protocol) or a descriptor loop.

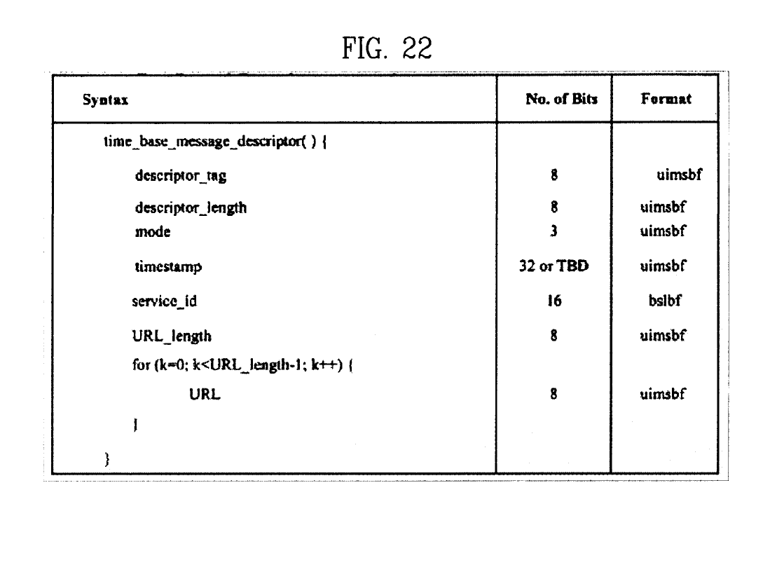

FIG. 22 is a diagram for a time base message descriptor according to one embodiment of the present invention.

A time base message descriptor according to one embodiment of the present invention can include descriptor_tag information, descriptor_length information, mode information, timestamp information, service_id information, URL_length information, and/or URL information.

Each of the informations included in the time base message descriptor is identical to the information included in the aforementioned time base message. The number of bits assigned to each of the informations may vary. A value of the timestamp information may have a value of a GPS or a value of a PTS depending on a service model.

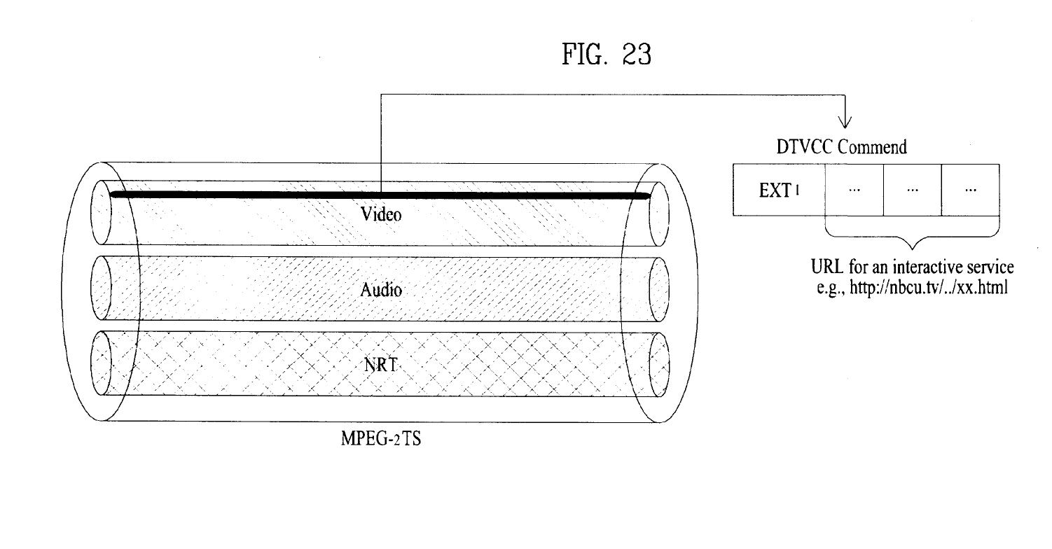

FIG. 23 is a diagram for MPEG2-TS transmitting a time base message according to a different embodiment of the present invention.

As depicted in FIG. 23, in case of transmitting a time base message on a DTV-CC, the time base message can be transmitted on a user data of a video header region within the MPEG-2 TS. In this case, a data structure of the time base message is identical to that of the aforementioned time base message. Yet, a form of transmitting a data of the time base message may use an extended form of an EXT1 code of the DTV-CC.

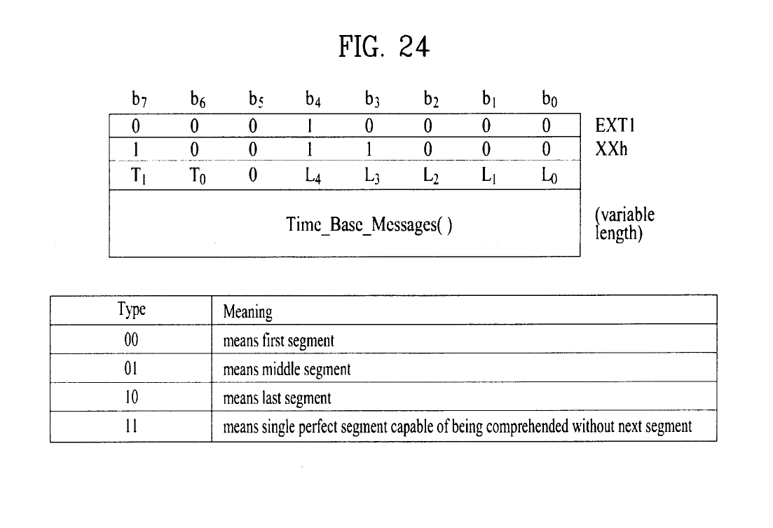

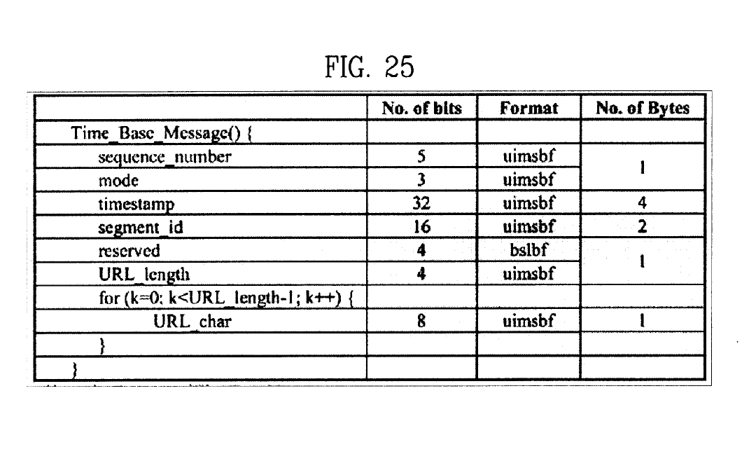

FIG. 24 is a diagram for an EXT1 code including a data of a time base message according to one embodiment of the present invention.

As depicted in FIG. 24, a data of a time base message can be transmitted in a manner of extending an EXT1 code of the DTV-CC.

The extended EXT1 code can include a type (T) field, a length (L) field, and/or a time_base_message( ) data.

The type (T) field includes 2 bits. If the type (T) field is set to ‘00’, it means a first segment. If the type (T) field is set to ‘01’, it means a middle segment. If the type (T) field is set to ‘10’, it means a last segment. If the type (T) field is set to ‘11’, it means a perfect segment capable of being comprehended without a next segment.

The length (L) field is an unsigned integer value and means a size of a data following a header. The length field may have a value between minimum 2 bytes and 27 bytes.

As mentioned in the foregoing description, the Time_Base_Message( ) may have a single URL form. Or, the Time_Base_Message( ) may have a metadata form.

FIG. 25 is a diagram for Time_Base_Message( ) included in an EXT1 code according to one embodiment of the present invention.

The meaning of each of the fields included in the Time_Base_Message( ) is identical or similar to the aforementioned content. And, regarding the value of each of the fields, a bit value may increase due to an additional definition according to a service range and usage of each field. In this case, a value of sequence_number can display a sequence of a packet with a value necessary for a case that T0 and T1 value include ‘01’. By doing so, a long data can be transmitted in a manner of being divided into a plurality of short packets.

In case that the T0 and T1 value have ‘11’, a value of the sequence_number field can be set to ‘0’. In case of a first segment, the sequence_number starts with ‘0’ and may have an incremental value. And, the sequence_number cannot be infinitely increased. If the sequence_number has ‘31’, which is a last value of a range of the value, the sequence_number has ‘0’ again.

As mentioned in the foregoing description, if the sequence_number has ‘0’ and the T0 and T1 value have ‘01’, a receiver may be aware that a current packet corresponds to a 32nd packet. The receiver recognizes the periodical repetition of the packets of the aforementioned condition. Hence, although data packet is continuously transmitted, the receiver continuously counts the condition (sequence_number=‘0’, T0 and T1=‘01’) and may be then able to identify how many times the packets are transmitted.

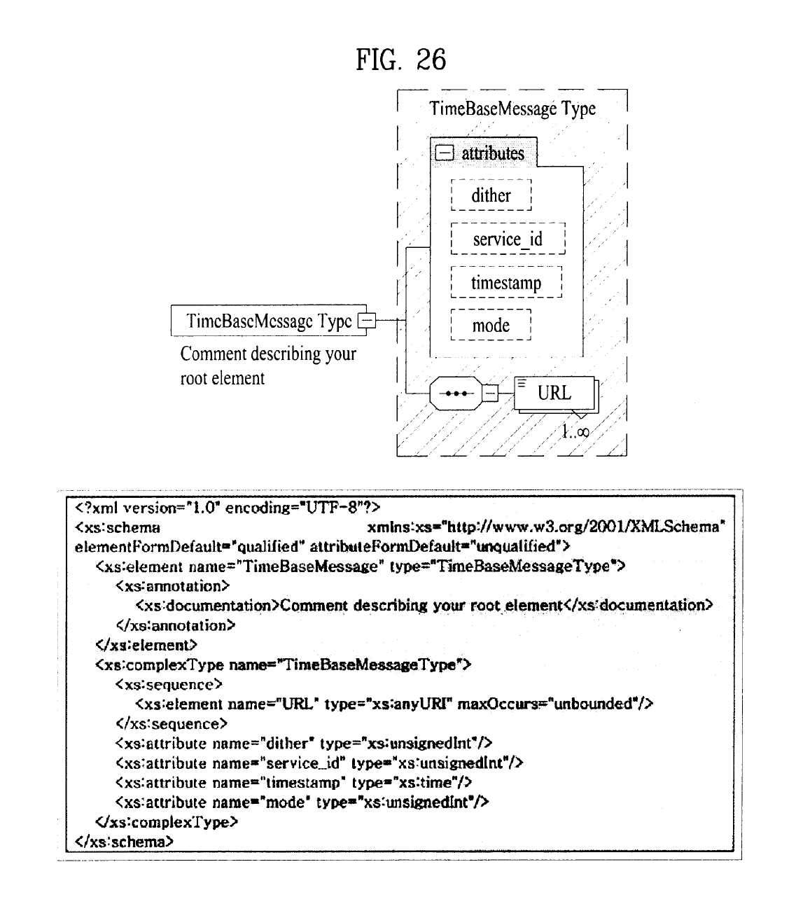

FIG. 26 is a diagram for a schema of a time base message and XSD syntax according to one embodiment of the present invention when the time base message is transmitted via the internet.

In case that a time base message is transmitted via the internet, the time base message can include a dither element, a service_id element, a timestamp element, a mode element, and/or a URL element. Explanation on each of the elements is replaced by the explanation on the information included in the aforementioned time base message.

Generally, the message can be transmitted on the internet using HTTP protocol. A receiver can receive the time base message from the ACR server or an internet server in a manner of making a request for the time base message once or periodically.

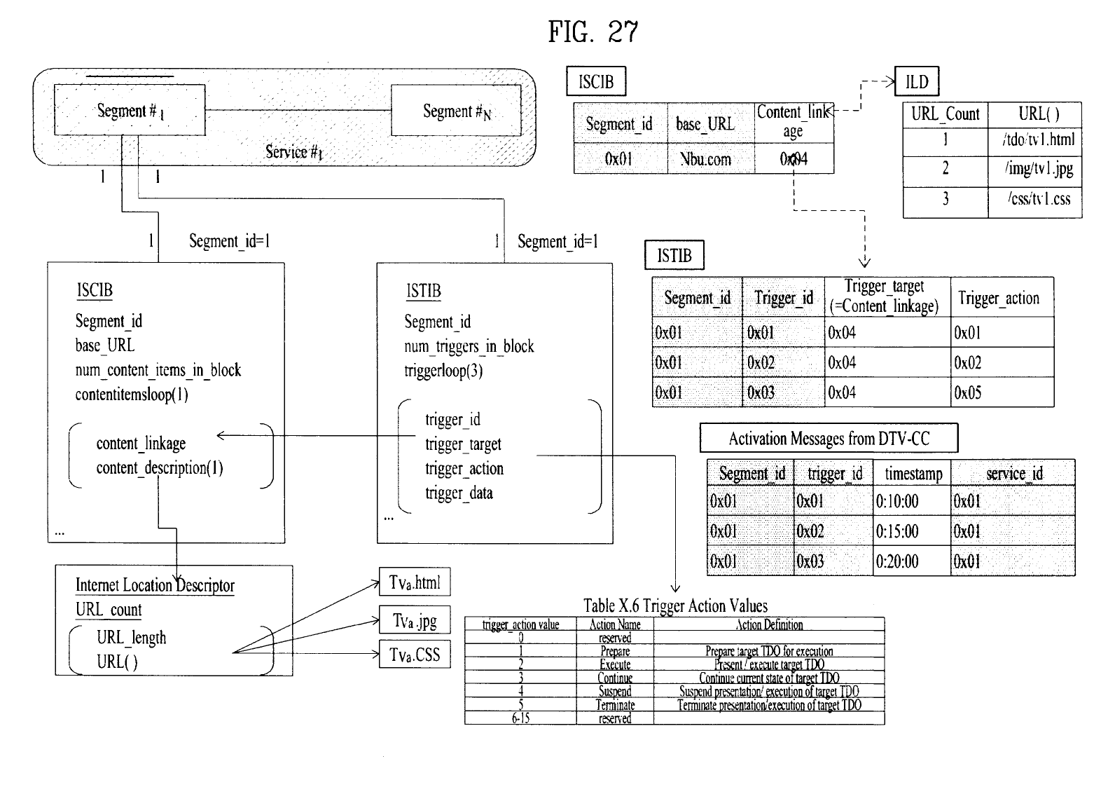

FIG. 27 is a diagram for a structure to signal a content item according to one embodiment of the present invention when the content item is executed in a segment of a service.

A content item may correspond to a video and/or an executable file. For clarity, assume that the content item corresponds to a TDO.

As shown in the drawing, there is a part represented by a red line positioned at an upper side of a segment #1 (a part of a program, in particular, one of broadcasting services consisted of a commercial provided after a part of a broadcast program is televised, a next part of the suspended program, and the like). The part represented by a red line corresponds to a part where an interactive service operates and it is able to see that one service operates only. The interactive service starts not long after the segment #1 has started. Schedule information for the interactive service is expressed by timestamp information which is included in an activation message. And, information corresponding to a trigger action, which indicates a prescribed operation on a time indicated by the timestamp information, is included in ISTIB. In particular, as mentioned in the foregoing description, information on a TDO is stored in a data structure called ISCIB and trigger informations are stored in a data structure called ISTIB. As mentioned in the foregoing description, the ISCIB and the ISTIB can be configured as a single file form or a single table. Moreover, the ISCIB and the ISTIB can also be configured as such a form as XML.

All of the segment_id are ‘1’ and a position of a content item corresponding to the ‘segment_id=1’ can be included in an internet location descriptor structure of the ISCIB in a URL form. One or more content items can be included in a content loop. In this case, files related to a TDO can be connected to each other instead of including a plurality of TDOs. A single TDO is included in one content loop in general.

Since a TDO can be transmitted in NRT, a receiver can judge whether all of a broadcast network and/or an internet network are accessible in a manner of classifying the ISCIB into available_in_broadcast information and available_on_internet information in order for the receiver to receive the TDO and/or a related file. By doing so, the receiver may be able to know where the TDO and/or the related files should be received.

One or more triggers can be included in the ISTIB. Each of the triggers may have unique trigger_id information. And, the ISTIB includes segment_id information indicating a segment to which each of the triggers belongs thereto. Since a plurality of triggers can be included in a segment, the ISTIB includes trigger_target information indicating a content item to which each of the triggers belongs thereto. The trigger_target information is matched with content_linkage information included in the ISCIB to connect a trigger to a content item.

The aforementioned ISCIB and/or the ISTIB may have one or more data at the same time. Hence, if a receiver receives a time base message from a broadcast network or the internet, a table regarding the ISCIB and/or the ISTIB can be received at the same time. Or, the receiver can receive data of an appropriate size according to a memory of the receiver. The receiver can receive the ISCIB and the ISTIB data a bit at a time. Or, the receiver can receive all of the ISCIB and the ISTIB data corresponding to a single segment all at once. The receiver can update informations belonging to the table in a manner of making a request for the ISCIB and the ISTIB on a constant interval (e.g., 30 minutes).

In case that the receiver stores the ISCIB and the ISTIB in a manner of making a request for the ISCIB and the ISTIB, a most important message is an activation message. Similar to the time base message, the activation message can be received via a broadcast network or an internet network together with the ISCIB and/or the ISTIB information or individually. The activation message includes service_id information, segment_id information, timestamp information, and/or trigger_id information. The activation message includes core information making a trigger operate.

Having received the activation message, the receiver performs a TDO on a designated time with the aforementioned mechanism in a manner of searching for the received fields in the table including the ISCIB and/or the ISTIB.

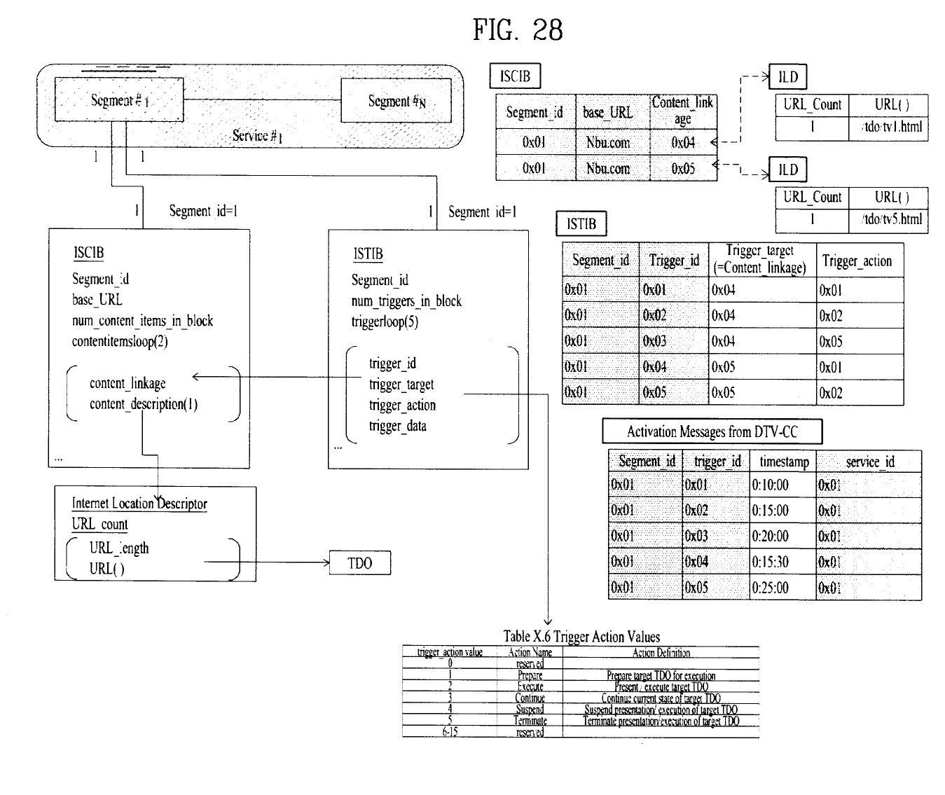

FIG. 28 is a diagram for a structure to signal a content item according to one embodiment of the present invention when pluralities of the content items are executed in a segment of a service.

Referring to FIG. 28, a red line and a thick line of grey color positioned at an upper side of a segment #1 mean two interactive services and the interactive services may mean a TDO. Each of tables including information of the ISCIB and the ISTIB includes informations on a content item executable in the segment #1.

As depicted in FIG. 28, the ISCIB includes values (e.g., ‘0x04’ and ‘0x05’) of content_linkage information different from each other. Each of ‘0x04’ and ‘0x05’ includes an independent URL( ) information and the independent URL( ) information can be checked via the internet location descriptor. Each TDO is indicated by a combination of the independent URL( ) information of ‘0x04’ and ‘0x05’ and base_URL. In particular, although ‘0x04’ and ‘0x05’ indicate TDOs different from each other, respectively, an identical base_URL can be used in a single segment.

The ISTIB includes values (e.g., ‘0x04’ and ‘0x05’) of content_linkage information (=content_linkage). It is able to know that an action for each trigger varies. Since trigger_id information should be unique in a single segment, it is able to know that a value of the trigger_id information increases by 1.

The activation message can include segment_id information, trigger_id information, service_id information, and/or timestamp information. Detail explanation on the informations is identical to the aforementioned content.

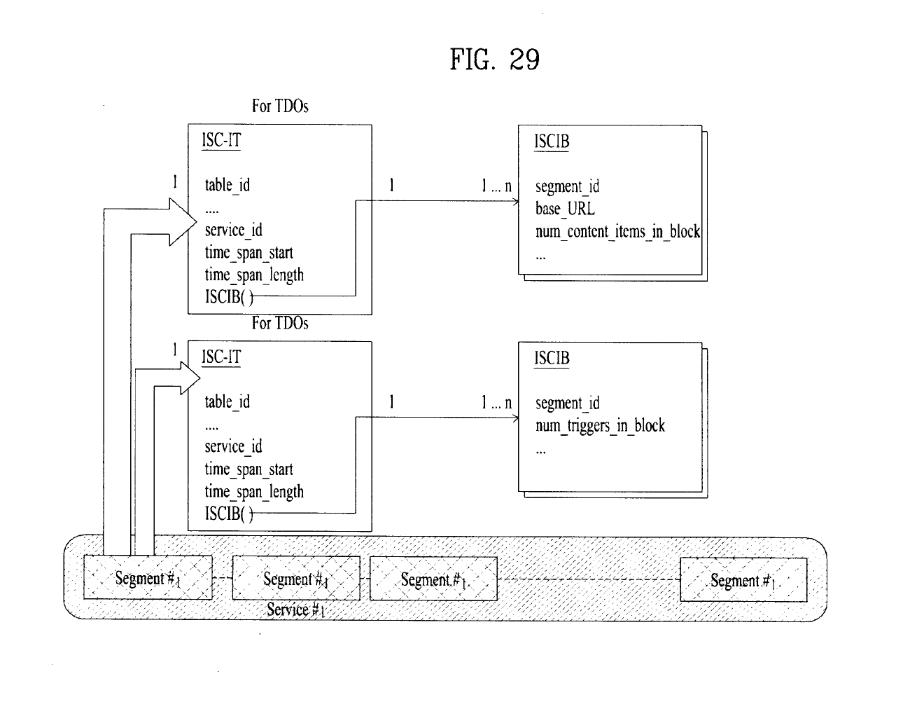

FIG. 29 is a diagram for a method of signaling an interactive service using a broadcast network in a segment-oriented mode according to one embodiment of the present invention.

As depicted in FIG. 29, a receiver can process the ISCIB and/or the ISTIB in a manner that the ISCIB and/or the ISTIB are transmitted by a HTTP protocol or an internet protocol via the internet in such a form as XML or a section table. The ISCIB and/or the ISTIB can be transmitted via a broadcast network. As mentioned in the foregoing description, in order to transmit the ISCIB and/or the ISTIB via the broadcast network, ISCIB data and ISTIB data are stored in an ISC-IT section table and an IST-IT section table, respectively. And then, the section tables can be transmitted via the broadcast network.

In case that a service mode corresponds to the segment-oriented mode, since a time indicated by time_span_start information is independent according to each segment, each segment may have one ISC-IT and one IST-IT applied to the corresponding segment. One or a plurality of informations of the ISCIB and/or the ISTIB can be included in each of the ISC-IT and the IST-IT.

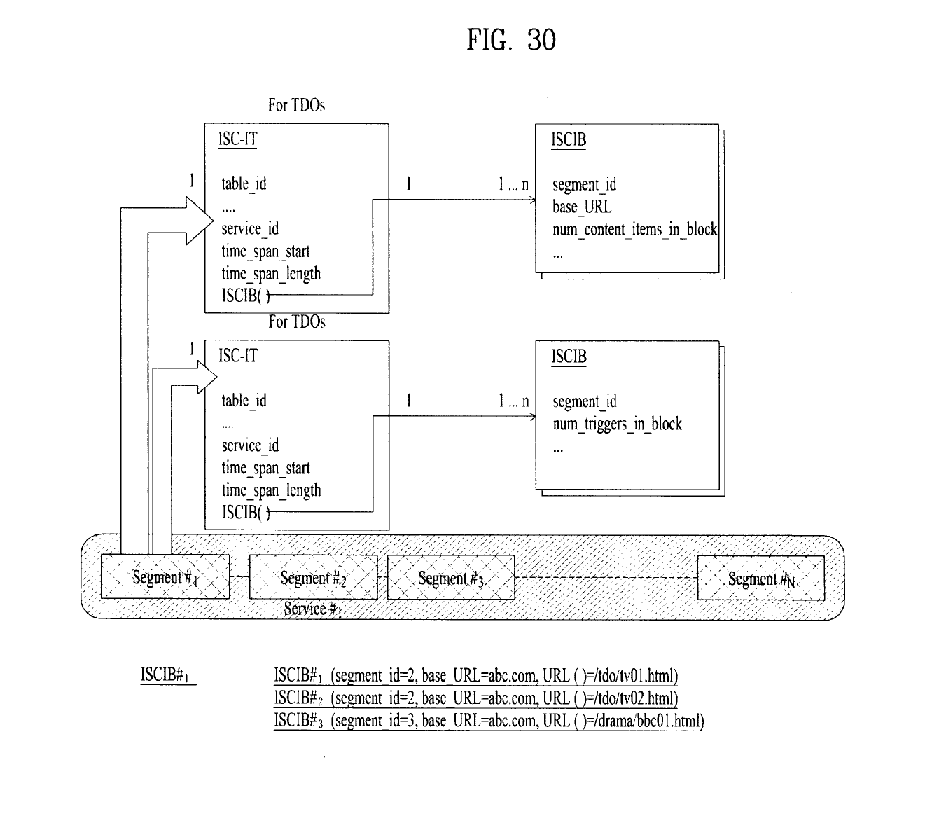

FIG. 30 is a diagram for a method of signaling an interactive service using a broadcast network in a service-oriented mode according to one embodiment of the present invention.

There exists a plurality of segments in a service. Instead of providing signaling information to each of a plurality of the segments, the signaling information is provided to the service (e.g., service #1). Hence, at least one ISC-IT and/or at least one IST-IT can be transmitted via a broadcast network for a content item related to the service #1 or a TDO.

For instance, ISCIB #1, ISCIB #2, and ISCIB #3 can be transmitted for the service #1 and the ISCIB #1 and the ISCIB #2 can signal a TDO, which is related to a segment #2 within the service #1, respectively. The ISCIB #3 can signal a TDO, which is related to a segment #3 included in the service #1.

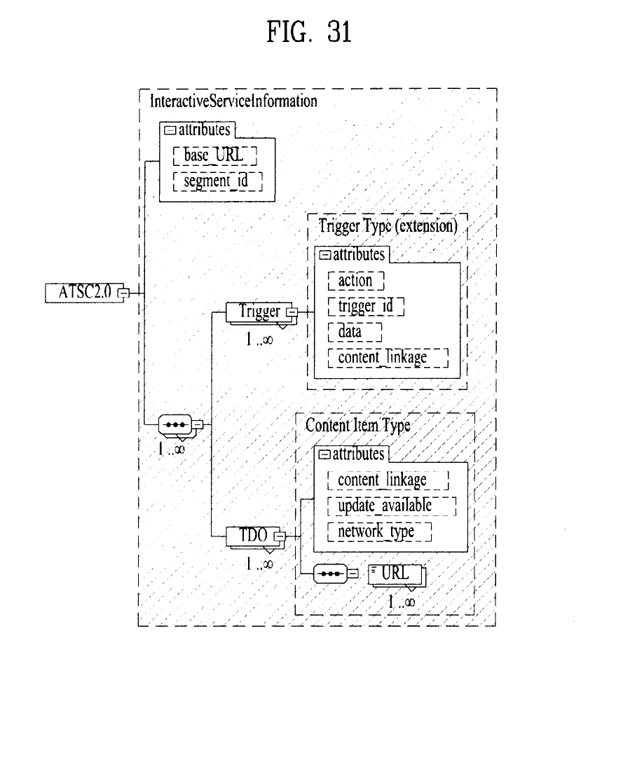

FIG. 31 is a diagram for a schema of interactive service information according to one embodiment of the present invention.

Interactive service information is a concept including the aforementioned ISCIB and the ISTIB. As depicted in FIG. 31, the ISCIB and the ISTIB can be expressed in an XML form in the interactive service information. The interactive service information can be configured by two types. The interactive service information can be stored in an internet server and transmitted to a receiver as a HTTP response in a manner of being configured by an XML file by a HTTP request.

The interactive service information can be received as a single XML file via the internet without the need for a receiver to receive a plurality of the ISCIB and the ISTIB.

The interactive service information according to one embodiment of the present invention includes a base_URL element, a segment_id element, a trigger element and/or a TDO element.

The trigger element can include an action element, a trigger_id element, a data element and/or a content_linkage element. Or, the trigger element may include information identical to one or more information among the informations included in the aforementioned ISTIB.

The TDO element can include a content_linkage element, an update_available element, and/or a network_type element. Or, the TDO element may include information identical to one or more information among the informations included in the aforementioned ISCIB.

The trigger element and the TDO element can include the content_linkage element, respectively.

According to the schema depicted in FIG. 31, the interactive service information includes the trigger element and the TDO element for each of the segments. Hence, a TDO for each of the segments and a signaling for triggers for each of the segments can be provided.

Explanation on each of the segments depicted in FIG. 31 is replaced by the explanation on the informations included in the aforementioned ISTIB and/or the ISCIB.

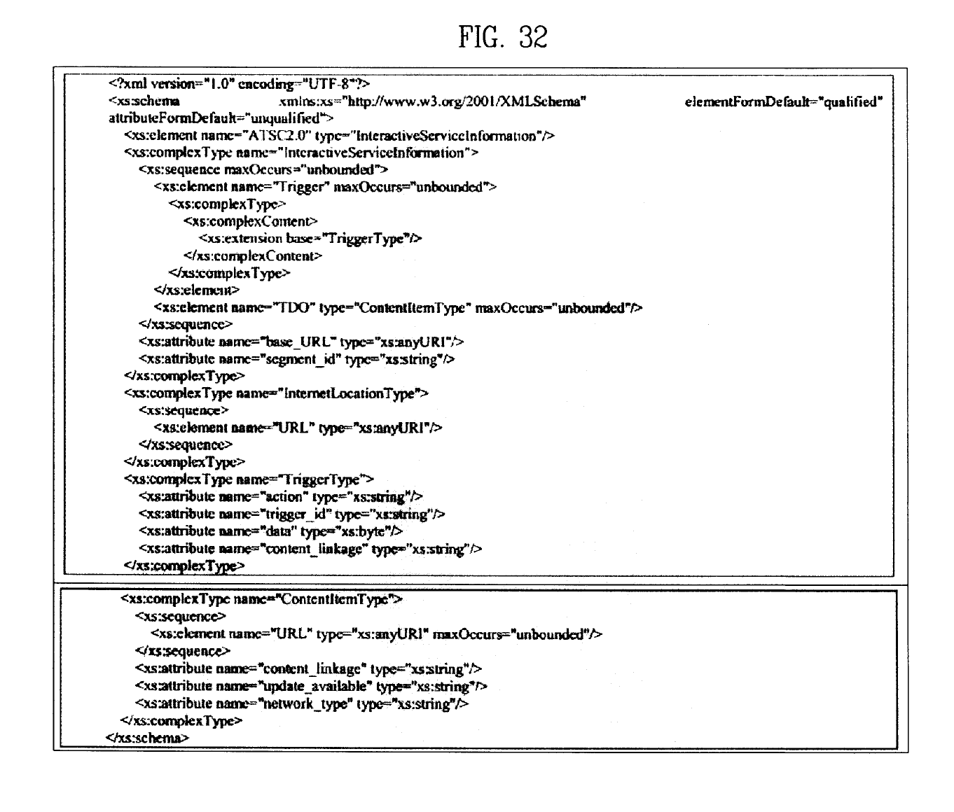

FIG. 32 is a diagram for interactive service information of an XSD form according to one embodiment of the present invention.

An XSD in FIG. 32 corresponds to a schema in FIG. 31 configured by an XSD form.

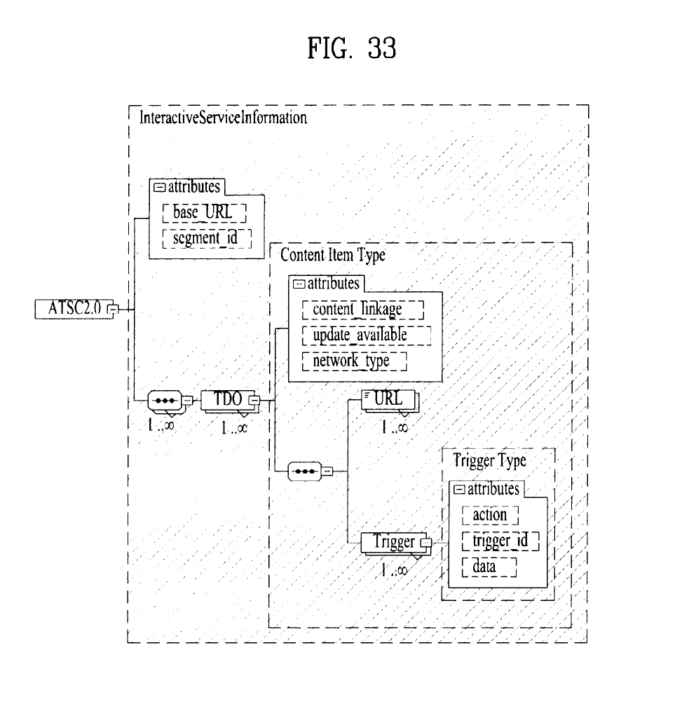

FIG. 33 is a diagram for a schema of interactive service information according to a different embodiment of the present invention.

According to a schema of interactive service information in accordance with a different embodiment of the present invention, a TDO related to each segment and a trigger related to each segment can be signaled without duplicately inserting the content_linkage element into ContenitemType and TriggerType. Hence, the ISCIB and the ISTIB can be efficiently configured as a single XML file.

The interactive service information according to a different embodiment of the present invention can include a base_URL element, a segment_id element, and/or a TDO element. The TDO element can include a content_linkage element, an update_available element, a network_type element, a URL element, and/or a trigger element. The trigger element can include an action element, a trigger_id element, and/or a data element.

Explanation on each of the elements depicted in FIG. 33 is replaced by the explanation on the informations included in the aforementioned ISTIB and/or the ISCIB.

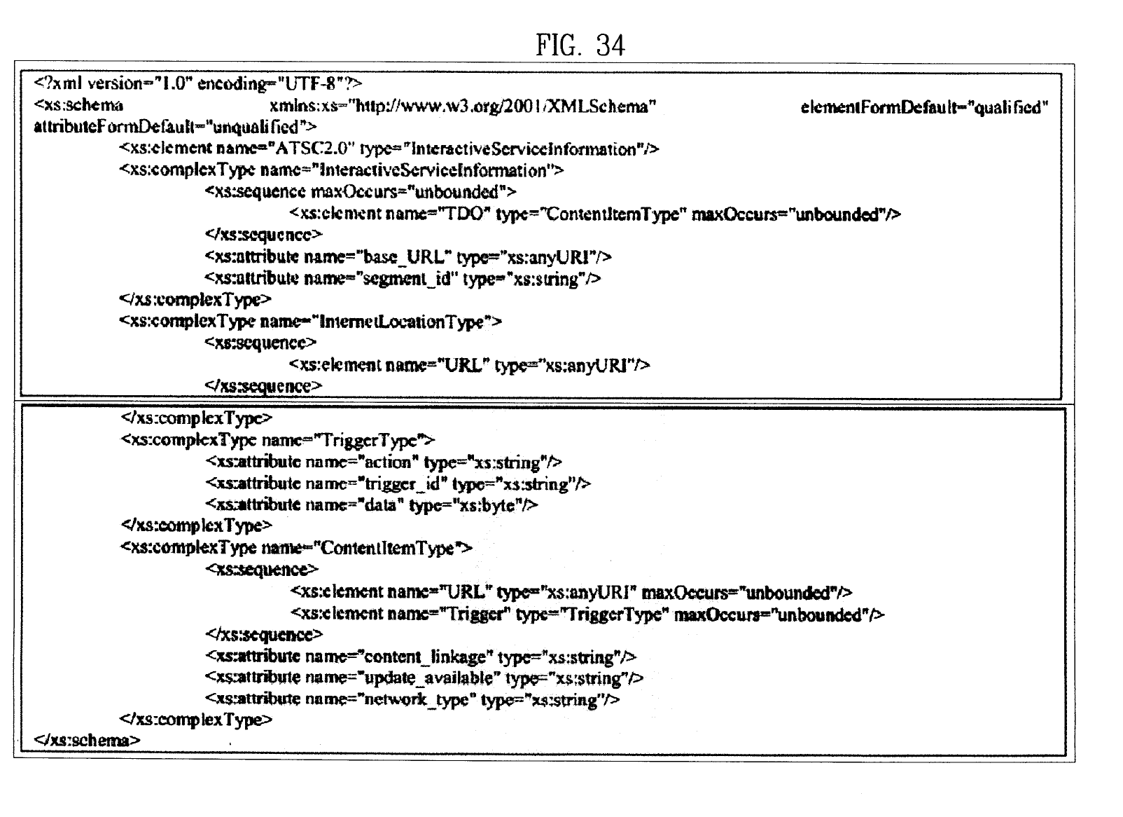

FIG. 34 is a diagram for interactive service information of an XSD form according to one embodiment of the present invention.

An XSD in FIG. 34 corresponds to a schema in FIG. 33 configured by an XSD form.

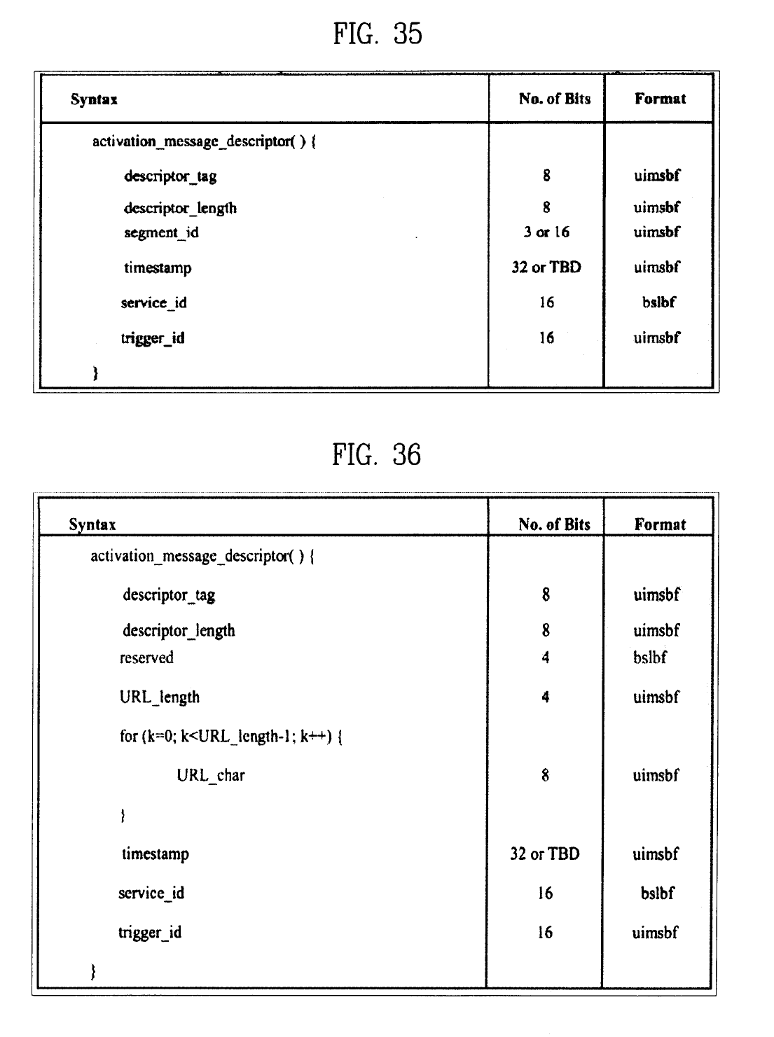

FIG. 35 is a diagram for an activation message descriptor according to one embodiment of the present invention.

The activation message descriptor according to one embodiment of the present invention can include segment_id information, trigger_id information, timestamp information, service_id information, and/or dither information.

Each of the informations can be transmitted in a manner of being configured in various forms. The informations can be made in a descriptor form capable of being included in a PES packet, a DTV-CC, an ES loop of a PMT, an EIT, or the like.

Explanation on each of the informations capable of being included in the activation message descriptor is replaced by the explanation on the informations, which have an identical name, included in the aforementioned activation message.

An activation message can be transmitted on an MPEG-2 TS elementary stream (ES). The activation message can be transmitted on a private section of a PES packet. The activation message can be transmitted in a manner of being included in an ES loop of an EIT and/or a PMT. The activation message can be transmitted via a caption region according to a DTV-CC in a form of an EXT1 code. In this case, the activation message can be transmitted by a scheme similar to the aforementioned scheme of transmitting the time base message. The activation message can be transmitted via the internet. In this case, the activation message can be transmitted in an XML form as a response of a HTTP protocol.

If an activation message is transmitted on the MPEG-2 TS elementary stream, the activation message descriptor depicted in FIG. 35 indicates a form capable of being transmitted in a manner of being included in a PES packet.

FIG. 36 is a diagram for an activation message descriptor according to a different embodiment of the present invention.

As depicted in FIG. 36, segment_id information included in the activation message descriptor can be expressed by URL information. The URL information of the aforementioned time base message can also be expressed by the segment_id information. In this case, the activation message descriptor can include URL_length information and URL_char information instead of the segment_id information.

The URL_length information indicates a length of the URL_char information.

The URL_char information indicates a URL as a text.

Different information capable of being included in the activation message descriptor depicted in FIG. 36 corresponds to information identical to the information included in the activation message descriptor depicted in FIG. 35 except that the segment_id information is replaced by the URL information.

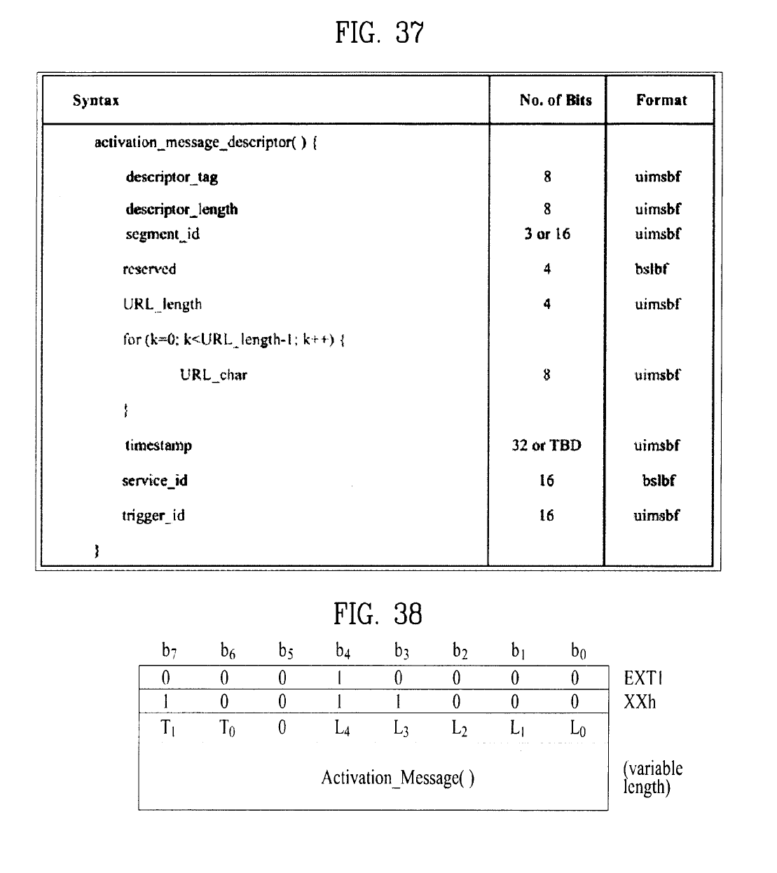

FIG. 37 is a diagram for an activation message descriptor according to a further different embodiment of the present invention.

According to a different embodiment of the present invention, the segment_id information within the activation message descriptor is used as a unique ID necessary to identify a segment. An additional URL field can be separately included in the activation message descriptor to access an internet server such as a signaling server and the like.

In particular, although the segment_id information may include a URL value in a manner of including a number or a string value, in some cases, there exists a separate URL field. A value of the segment_id information may have a series of number values only for a unique purpose of identifying a segment.

Explanation on the information included in the activation message descriptor according to a different embodiment of the present invention is replaced by the explanation on the information having a name identical to that of the information included in the activation message descriptor depicted in FIG. 35 and FIG. 36.

FIG. 38 is a diagram for an EXT1 code format including a data of an activation message according to one embodiment of the present invention.

As mentioned in the foregoing description, an activation message can be transmitted on a DTV-CC. In this case, a data of the activation message can be transmitted by an EXT1 code of the DTV-CC.

The EXT1 code configured to transmit the data of the activation message can include a type (T) field, a length (L) field, and/or an activation message( ) data.

The type (T) field includes 2 bits. If the type (T) field is set to ‘00’, it means a first segment. If the type (T) field is set to ‘01’, it means a middle segment. If the type (T) field is set to ‘10’, it means a last segment. If the type (T) field is set to ‘11’, it means a perfect segment capable of being comprehended without a next segment.

The length (L) field is an unsigned integer value and means a size of a data following a header. The length field may have a value between minimum 2 bytes and 27 bytes.

The activation message( ) includes a unique identifier and can be defined as a metadata form.

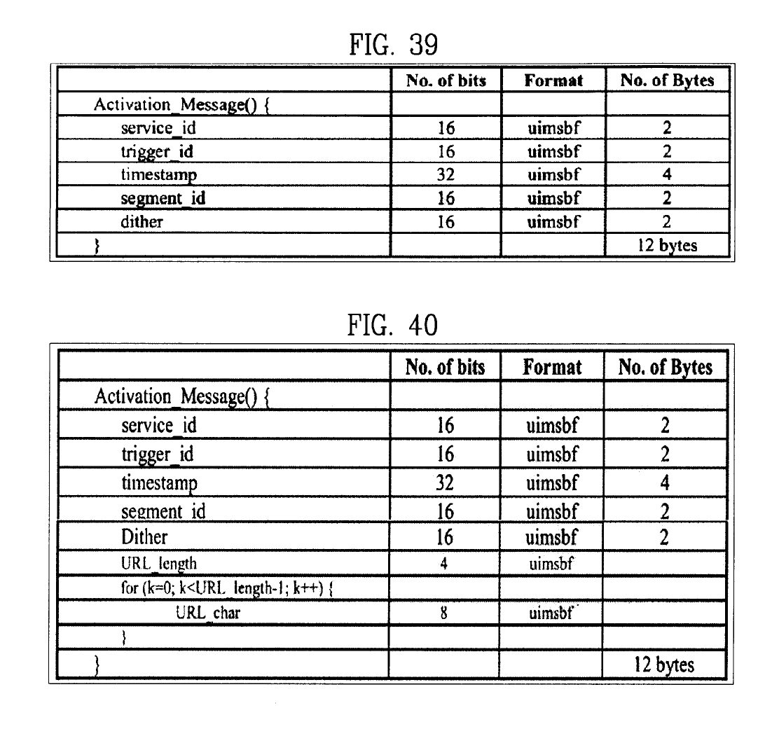

FIG. 39 is a diagram for an Activation Message( ) included in an EXT1 code according to one embodiment of the present invention.

The Activation Message( ) included in an EXT1 code can include service_id information, trigger_id information, timestamp information, segment_id information and/or dither information.

Explanation on the informations included in the activation message( ) which is included in the EXT1 code, is replaced by the explanation on the informations having a name identical to that of the informations included in the aforementioned activation message.

FIG. 40 is a diagram for an Activation Message( ) included in an EXT1 code according to a different embodiment of the present invention.

The activation message( ) included in the EXT1 code according to a different embodiment of the present invention may include URL_length information and URL_char information in addition to the activation message( ) depicted in FIG. 39. In this case, the segment_id information can be used as a number value. The segment_id information is used as information to identify a segment only. If it is not used as globally unique segment_id information in a broadcast channel, a URL may be used.

Explanation on the informations included in the activation message( ) which is included in the EXT1 code according to a different embodiment of the present invention, is replaced by the explanation on the informations having a name identical to that of the informations included in the aforementioned activation message.

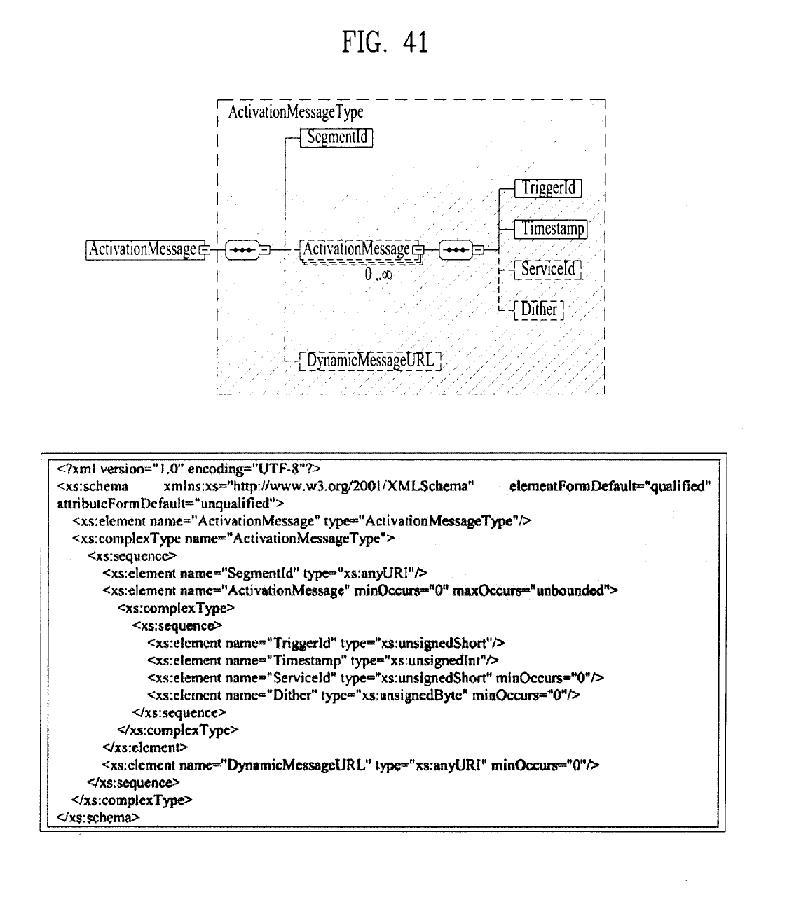

FIG. 41 is a diagram for a schema to transmit an activation message on the internet and XDS syntax according to one embodiment of the present invention.

A schema to transmit an activation message according to one embodiment of the present invention can include a SegmentID element, an ActivationMessage element, and/or a DynamicMessageURL element. The ActivationMessage element includes a TriggerID element, a Timestamp element, a ServiceID element, and/or a Dither element.

Explanation on each of the elements is replaced by the explanation on the informations having a name identical to that of the informations included in the aforementioned activation message.

Referring to FIG. 41, the schema of the activation message including the aforementioned structure can be expressed in an XDS form.

A message of the XDS form can be transmitted on the internet using a HTTP protocol. A receiver can receive the activation message of the XDS form from the ACR server or an internet server in a manner of making a request for the activation message once or periodically.

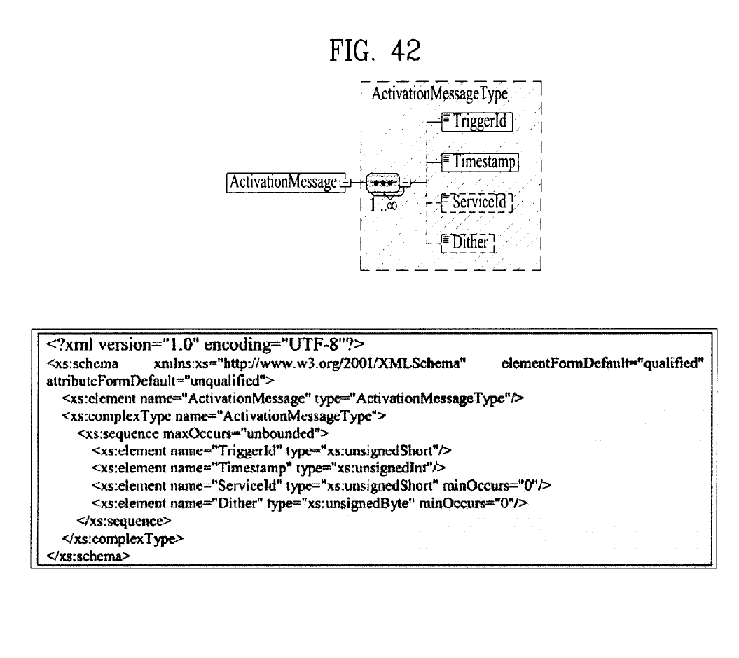

FIG. 42 is a diagram for a schema to transmit an activation message on the internet and XDS syntax according to a different embodiment of the present invention.

As mentioned in the foregoing description, an activation message is classified into a static activation message and a dynamic activation message. Unlike the activation message transmitted in a manner of being determined in advance, the dynamic activation message is used in case that the activation message is dynamically generated and transmitted on an unknown time. In this case, the dynamic activation message can include a Trigger_id element, a Timestamp element, a Service_id element, and/or a Dither element.

Explanation on each of the elements is replaced by the explanation on the informations having a name identical to that of the informations included in the aforementioned activation message.

A difference between the dynamic activation message and the activation message mentioned in FIG. 41 is that the dynamic activation message does not include the Segment_id element and the DynamicMessageURL element.

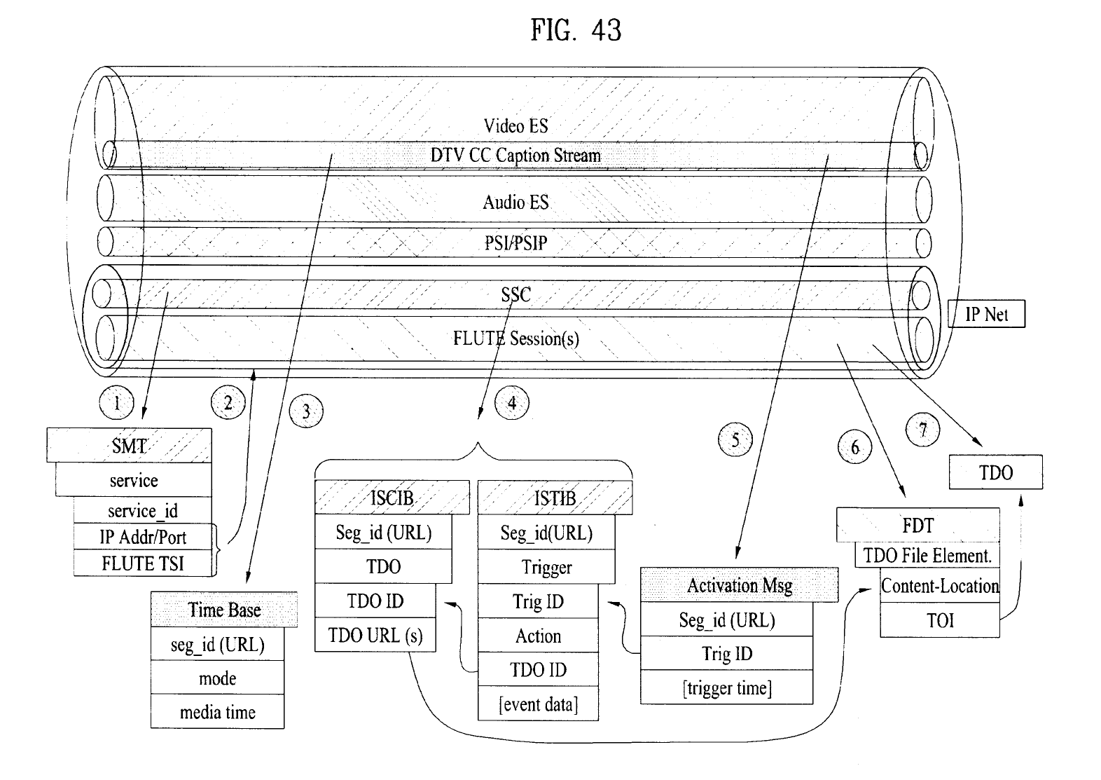

FIG. 43 is a diagram for a process of operating a TDO according to one embodiment of the present invention when an NRT service is supported in a state that a receiver is not connected to the internet.

A time base message is transmitted on a DTV-CC and the message includes seg_id (URL), i.e., segment_id information and mode information indicating a service form. And, the time base message may also include media time information indicating a timestamp value.

As mentioned in the foregoing description, the time base message and/or the activation message can be transmitted on the DTV-CC, a PES packet of MPEG-2 TS, or the like. For clarity, assume that the time base message and/or the activation message are transmitted on the DTC-CC in a following scenario and technical expression.

A receiver obtains SMT information from a service signaling channel (SSC, ATSC-NRT standard) and can identify a FLUTE session on which an interactive adjunct service related to a specific service or content is transmitted from the SMT information. Refers to the content explained in FIG. 2 for this process. In particular, the receiver can obtain a FDT and a TDO by performing this process.

ISCIB and ISTIB can be transmitted on the service signaling channel in a manner of being piled up with a section table called ISC-IT and IST-IT. If this information is collected, one or a plurality of ISCIB and ISTIB or single interactive service information (it can be defined by a TDO parameter table) including the information of the ISCIB and the ISTIB can be obtained. These informations are stored in the receiver. When an activation message is transmitted using such a loop as a DTV-CC, a PES packet, a PSIP, an EIT, and the like, the receiver refers to the informations.

When the activation message is received, the receiver searches for relevant ISCIB and ISTIB information via the seg_id (URL), i.e., the segment_id and the Trig ID (Trigger_ID), and the like. By doing so, the receiver searches for a TDO where a value of TDO_URL in the ISCIB is matched up with ‘content-location’ information in a FDT and may be then able to receive the TDO.

While receiving a corresponding FLUTE session after the SMT process, the receiver can store a required TDO and relevant files in storage of the receiver.

Subsequently, the TDO operates in accordance with Trigger_time information included in the activation message and an action (trigger action information) of the ISTIB.

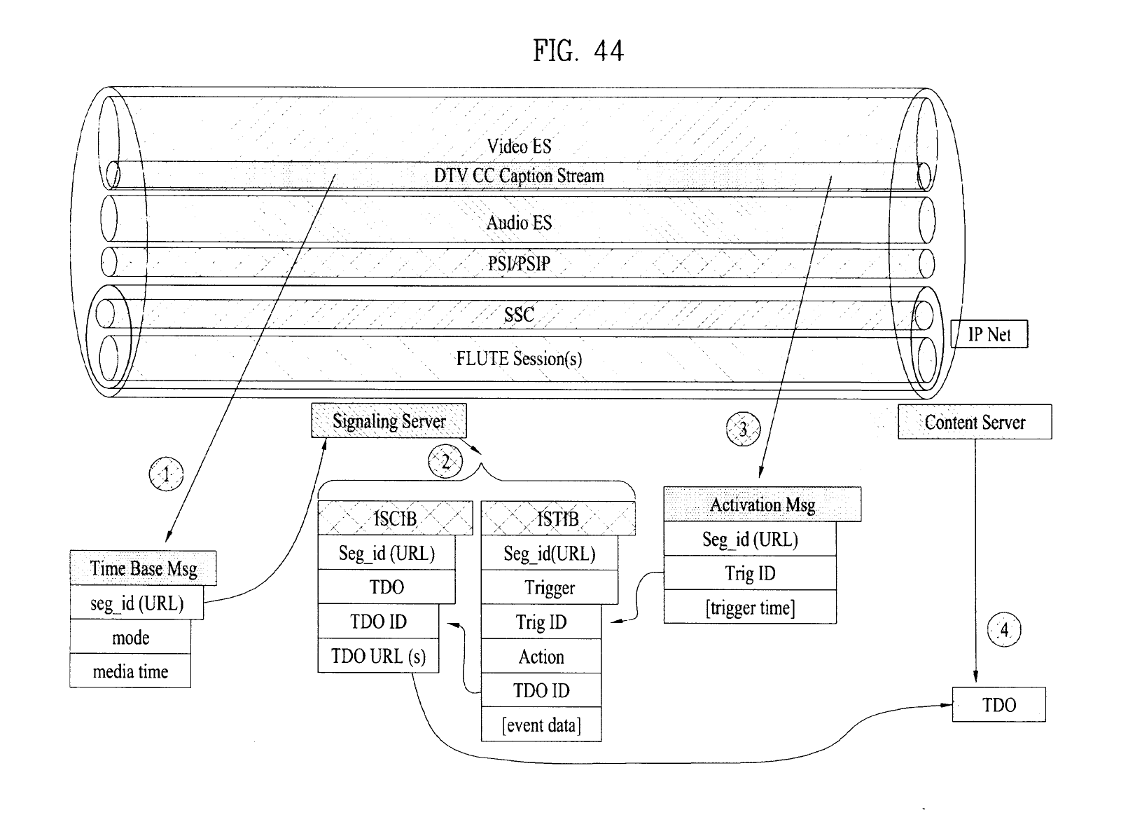

FIG. 44 is a diagram for a process of operating a TDO according to one embodiment of the present invention when an NRT service is supported in a state that a receiver is connected to the internet.

A time base message can be transmitted on a DTV-CC or a PES packet of MPEG-2 TS. If Seg_id (URL), i.e., segment_id information is used as a URL, a receiver can access a signaling server using URL information of the segment_id information. As mentioned in the foregoing description, the segment_id information may correspond to a unique identifier to identify a segment. If necessary, the segment_id information may additionally include a URL to inform the signaling server.

A receiver receives data of the ISCIB and/or the ISTIB by accessing the signaling server. As mentioned earlier in FIG. 43, if an activation message is transmitted on the DTV-CC, the receiver obtains a TDO_URL suitable for an interactive service in a manner of searching for corresponding information in the stored ISCIB and/or the ISTIB.

The receiver makes a TDO operate in accordance with the timestamp information (trigger time) of the activation message and the action information (trigger action) of the ISTIB. In this case, the receiver receives the time base message and the activation message via a broadcast network and can receive the rest of informations via the internet.

According to the embodiments explained in FIG. 43 and FIG. 44, the informations required when interactive service information and/or a TDO are received via the internet can also be transmitted via a broadcast network. And, in case of a common file or data, if it is transmitted in NRT, a broadcast network bandwidth can be efficiently utilized.

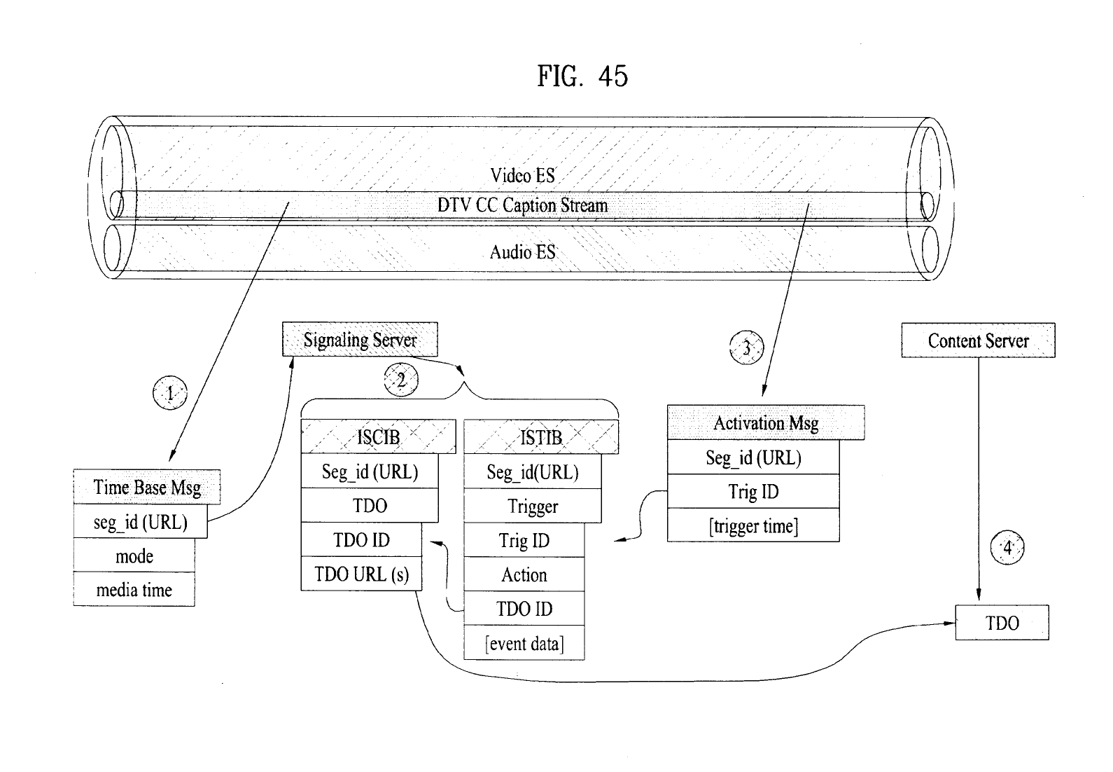

FIG. 45 is a diagram for a process of operating a TDO according to one embodiment of the present invention when an NRT service is not supported, although a receiver is connected to the internet.

According to the present embodiment, a time base message and an activation message can be received via a broadcast network. Yet, a receiver does not support an NRT service. Hence, the receiver should download all additional informations necessary for an interactive adjunct service and a TDO via the internet.

The receiver receives the time base message transmitted on the DTV-CC and obtains URL information of a signaling server from seg_id (URL), i.e., segment_id information of the time base message. The receiver receives interactive service information including ISCIB and/or ISTIB in a manner of accessing the signaling server. If an activation message is received, the receiver identifies a TDO related to a corresponding trigger in the interactive service information using Trig ID (trigger_id information) of the activation message and obtains TDO URL information on the TDO. The receiver accesses a content server providing the TDO using the TDO URL information and receives the TDO. By doing so, the receiver can perform an operation of a trigger indicated by the action information included in the interactive service information on a time (trigger time) indicated by the timestamp information of the activation message.

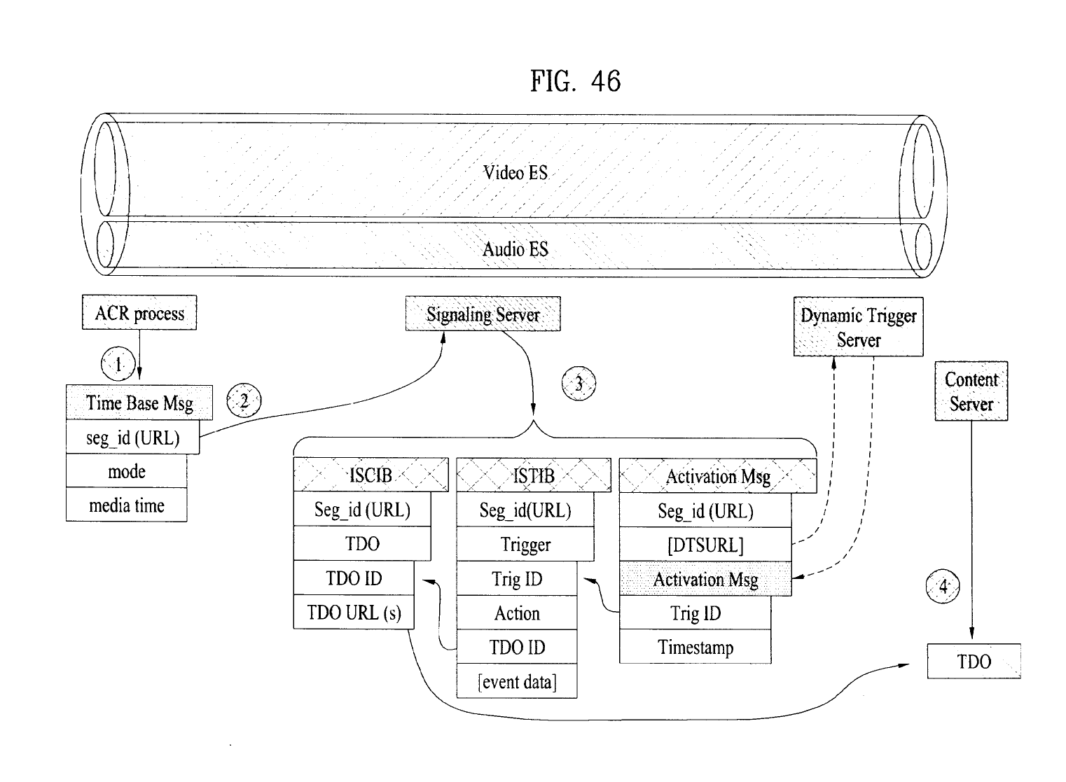

FIG. 46 is a diagram for a process of operating a TDO operated by an ACR receiver according to one embodiment of the present invention.

The present embodiment corresponds to a scenario that a set-top box receives a broadcast program received via a broadcast network, decodes the broadcast program, and transmits a corresponding program data to a receiver connected to the set-top box. According to the scenario, the receiver does not directly decode a broadcast stream.

The receiver cannot obtain additional data on a video and an audio. The receiver plays a video data (e.g., YCbCr, RGB) and an audio data (e,g, AC-3, Wave) only in a screen.

If an ACR (automatic content recognition) module is installed, the ACR module installed in the receiver captures a currently playing video and audio, extracts finger print information or watermark information from the captured video and audio, transmits information on the fingerprint information or the watermark information to a designated ACR server, and receives a time base message from the ACR server.

As mentioned in the foregoing description, the time base message informs the receiver of an address of a signaling server. The receiver obtains interactive service information including the ISCIB and/or ISTIB from the signaling server and can additionally obtain an activation message.

In the previous scenario, the activation message is received via the broadcast network. Yet, the receiver according to the present scenario cannot directly access the broadcast network and should recognize broadcast content using the ACR module since the internet network is directly connected to the receiver only.

Having obtained the activation message, the receiver receives a TDO by performing the aforementioned process and makes the TDO operate.

Meanwhile, if a time (trigger time) indicated by the timestamp information is not designated in the activation message, DynamicMessage URL information can be included in the activation message to make the receiver additionally receive a dynamic activation message. The receiver can obtain the dynamic activation message including the trig_id (trigger_id information) and the trigger_time (timestamp information) in a manner of accessing a URL according to the DynamicMessage URL information.

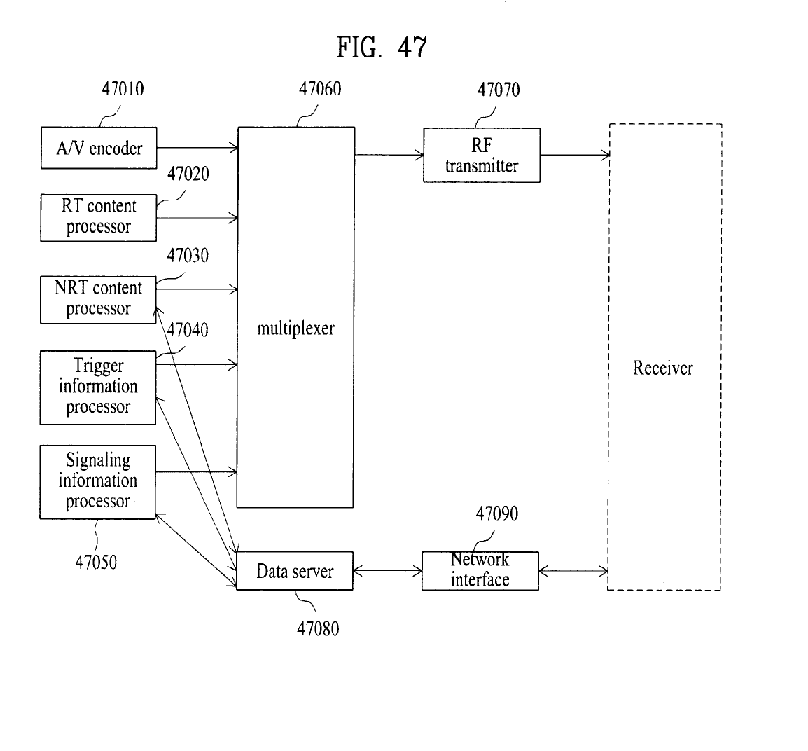

FIG. 47 is a diagram for a broadcast transmission system according to one embodiment of the present invention.

The broadcast transmission system according to one embodiment of the present invention includes an A/V encoder 47010, an RT content processor 47020, an NRT content processor 47030, a trigger information processor 47040, a signaling information processor 47050, a multiplexer 47060, an RF transmitter 47070, a data server 47080, and/or a network interface 47090.

The A/V encoder 47010 encodes a video and an audio signal consisting of a broadcast program.

The RT content processor 47020 generates real time content and performs a process to provide the real time content to a receiver.

The NRT content processor 47030 generates non-real time content and performs a process to provide the non-real time content to a receiver. The non-real time content may include an interactive adjunct service such as the aforementioned TDO.

The trigger information processor 47040 generates trigger information including the aforementioned time base message (or time base trigger) and/or the activation message (or activation trigger) and performs a process to transmit the trigger information to a receiver. The trigger information generated by the trigger information processor 47040 may be transmitted to the data server and stored in the data server 47080.

The signaling information processor 47050 generates interactive service information including the aforementioned ISTIB, the ISCIB, and/or the TDO parameter table (TPT) and performs a process to transmit the interactive service information to a receiver. The signaling information processor 47050 generates signaling information related to PSI/PSIP and may perform a process to transmit the signaling information to a receiver.

The multiplexer 47060 multiplexes an encoded video and audio signal, real time content, non-real time content, trigger information, PSI/PSIP information, and/or interactive service information.

The RF transmitter 47070 performs a process to transmit a multiplexed signal as an RF signal.

The data server 47080 stores non-real time content, trigger information, and/or interactive service information. If a receiver makes a request for the non-real time content, the trigger information, and/or the interactive service information, the data server performs a role of delivering them to the receiver. The data server 47080 may include a plurality of servers. Each of a plurality of the servers stores the non-real time content, the trigger information, or the interactive service information, respectively, and can provide the receiver with the non-real time content, the trigger information, or the interactive service information, respectively.

The network interface 47090 performs a signal processing for an interactive communication between the data server 47080 and a receiver.

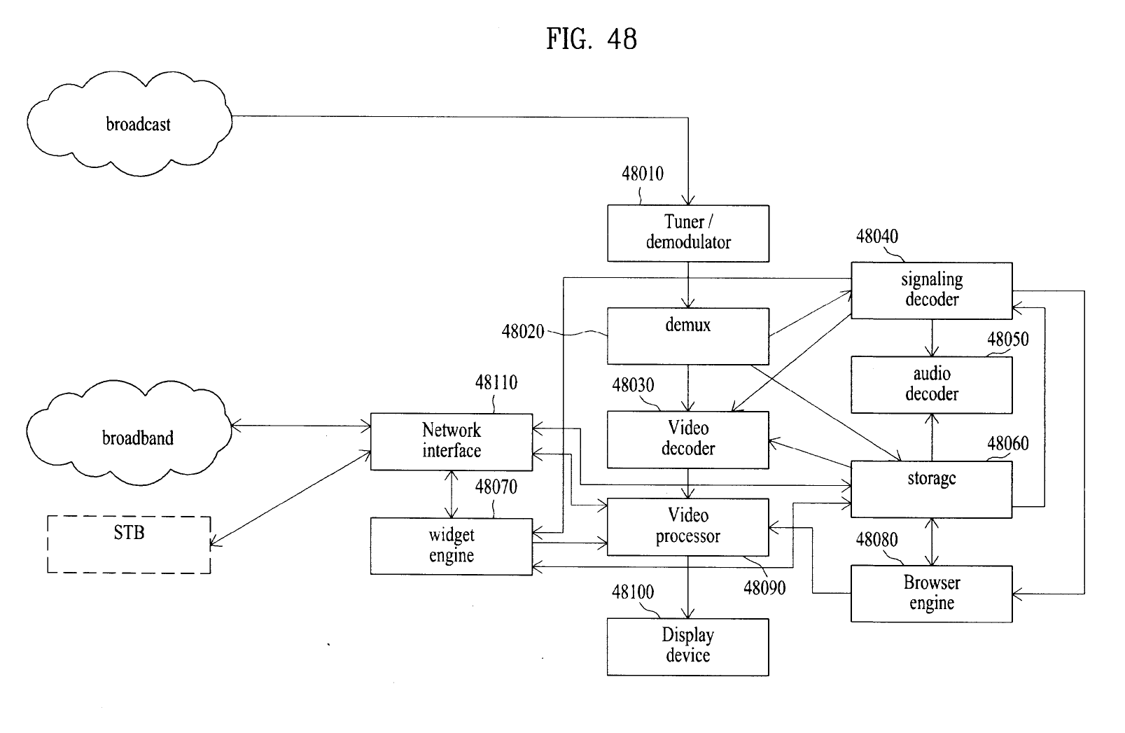

FIG. 48 is a diagram for a broadcast receiver according to one embodiment of the present invention.

The broadcast receiver according to one embodiment of the present invention includes a tuner/demodulator 48010, a demultiplexer 48020, a video decoder 48030, a signaling decoder 48040, an audio decoder 48050, a storage 48060, a widget engine 48070, a browser engine 48080, a video processor 48090, a display device 48100, and/or a network interface 48110.

The tuner/demodulator 48010 plays a role of receiving a real time or non-real time broadcast signal and demodulating the real time or non-real time broadcast signal.

The demultiplexer 48020 demultiplexes a real time or non-real time broadcast signal and then extracts a video data, an audio data, and signaling information from the real time or non-real time broadcast signal.

The video decoder 48030 performs a role of decoding a video data. The video decoder 48030 can decode the video data received in real time. And, the video decoder can extract and decode the video data stored in the storage 48060 in a manner of being received in non-real time. The video decoder 48030 can use signaling information in a process of decoding the video data.

The signaling decoder 48040 performs a role of parsing signaling information included in a broadcast signal. For instance, the signaling decoder 48040 can parse trigger information such as a time base message (or a time base trigger) transmitted on a broadcast signal and/or an activation message (or an activation trigger), interactive service information, and/or PSI/PSIP information. And, the signaling decoder 48040 makes a request for the signaling information stored in the storage 48060 and can parse the signaling information in a manner of receiving the signaling information. For instance, such interactive service information as the aforementioned ISCIB, ISTIB, and/or the TPT may be stored in the storage 48060. Or, such trigger information as the aforementioned time base message (or the time base trigger) and/or the activation message (or the activation trigger) may be stored in the storage 48060.

The audio decoder 48050 decodes an audio signal.

The storage 48060 can store real time content transmitted on a broadcast network or non-real time content. The storage 48060 can store an interactive service (e.g., a TDO) trigger information provided via the internet network and/or interactive service information. This sort of information can be transmitted to a corresponding unit according to a request of the corresponding unit on an appropriate time.

The widget engine 48070 performs a role of processing a TDO. The widget engine 48070 performs overall processing related to the TDO to make the TDO appear on a time on which the TDO should operate using the trigger information and/or the interactive service information. In particular, the widget engine 48070 performs a series of operations to receive the aforementioned TDO.

The browser engine 48080 performs a role of controlling necessary data or information to be delivered to each unit in a manner of searching for the content item, the trigger information, and the interactive service information stored in the storage. If a TDO is processed, the browser engine 48080 receives subsidiary data related to the TDO from the storage 48060 and delivers the subsidiary data to the video processor 48090.

The video processor 48090 performs a role of rendering a video image and the TDO processed by the widget engine 48070 into a video. In the process of rendering the TDO into the video image, the video processor 48090 receives a subsidiary data capable of being included in the TDO from the browser engine 48080 and can render the subsidiary data to be appeared as a video together with the TDO.

The display device 48100 displays the video processed by the video processor 48090.

The network interface 48110 is a device configured to process a signal to perform a communication with an external device. For instance, the network interface 48110 performs a role of processing a data signal to perform a communication between a server and a receiver via the internet. Or, the network interface 48110 may perform a role of delivering a video and audio data to a receiver via a communication with a set-top box or delivering a request of the receiver to the set-top box.

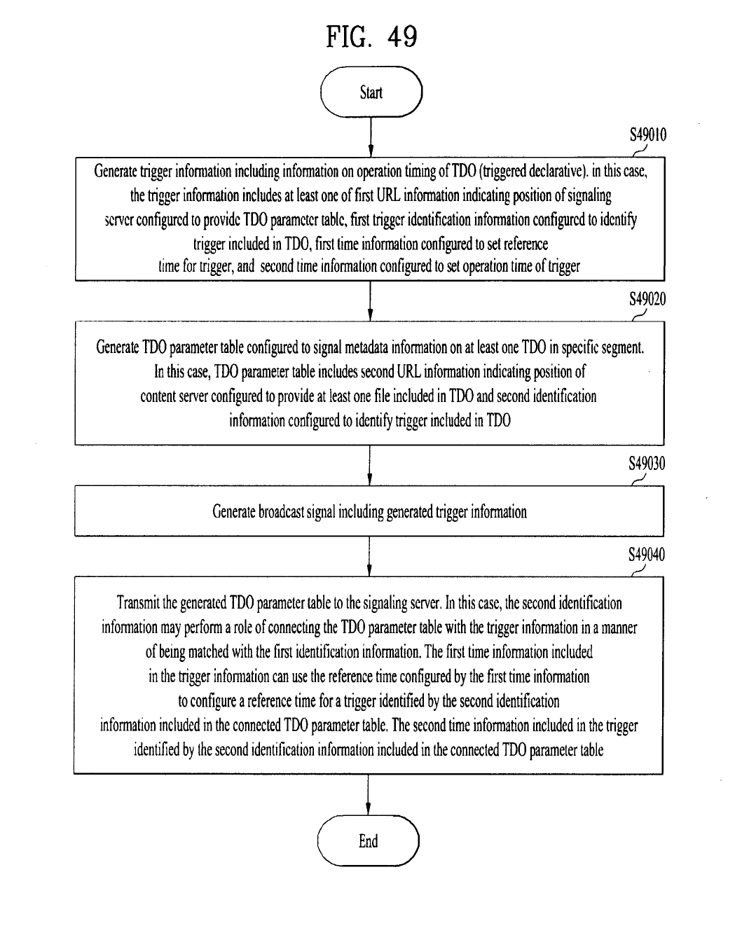

FIG. 49 is a flowchart of a method of processing an interactive service related to a broadcast program according to one embodiment of the present invention.

According to one embodiment of the present invention, a transmitter generates trigger information including information on operation timing of a TDO (triggered declarative object) [S49010]. In this case, the trigger information can include at least one of a first URL information indicating a position of a signaling server configured to provide a TDO parameter table, a first trigger identification information configured to identify a trigger included in the TDO, a first time information configured to set a reference time for the trigger, and a second time information configured to set operation time of the trigger.

The transmitter generates a TDO parameter table configured to signal metadata information on at least one TDO in a specific segment [S49020]. In this case, the TDO parameter table may include second URL information indicating a position of a content server configured to provide at least one file included in the TDO and second identification information configured to identify a trigger included in the TDO.

The transmitter generates a broadcast signal including the generated trigger information [S49030].

The transmitter transmits the generated TDO parameter table to the signaling server [S49040].

In this case, the second identification information may perform a role of connecting the TDO parameter table with the trigger information in a manner of being matched with the first identification information. The first time information included in the trigger information can use the reference time configured by the first time information to configure a reference time for a trigger identified by the second identification information included in the connected TDO parameter table. The second time information included in the trigger information can use the operation time configured by the second time information to configure operation time for a trigger identified by the second identification information included in the connected TDO parameter table.

For clarity of explanation, each diagram is explained in a manner of being divided. Yet, it is possible to design a new embodiment to implement the new embodiment by combining the embodiments, which are described in each of the diagrams. And, according to the necessity of those skilled in the art, designing a recording media readable by the computer, which has recorded a program for executing the previously explained embodiments, also belongs to a scope of a right.

A device and a method according to the present invention may not limitedly apply to the composition and method of the aforementioned embodiments. The aforementioned embodiments may be configured in a manner of being selectively combined the whole of the embodiments or a part of the embodiments to achieve various modifications.

Meanwhile, a method of processing an interactive service related to a broadcast program according to the present invention can be implemented with a code readable by a processor in a recording media readable by the processor, which is equipped in a network device. The recording media readable by the processor may include all kinds of recording devices for storing data capable of being read by the processor. The examples of the recording media readable by the processor may include a ROM, a RAM, a magnetic tape, a floppy disc, an optical data storing device and the like. And, implementing in a form of a carrier wave such as a transmission via the internet and the like is also included. And, since the recording media readable by the processor are distributed to the computers connected by a network, codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

And, both an apparatus invention and a method invention are explained in the present specification and the explanation on both of the inventions can be complementally applied, if necessary.

### MODE FOR INVENTION

As mentioned in the foregoing description, the related is described in the best mode for invention.

### INDUSTRIAL APPLICABILITY

The present invention can be usable in a series of industry fields related to a broadcasting service providing.

1-10. (canceled)

11. A receiver for processing an interactive service related to a program, the receiver comprising:
a tuner configured to receive trigger information including information for operation timing of a TDO (Triggered Declarative Object), wherein the trigger information include first URL information specifying a location of a signaling server providing a TDO parameter table, first trigger identification information identifying a trigger event included in the TDO, and at least one of first time information specifying a time base for the trigger event and second time information specifying an activation time for the trigger event;
a first network interface configured to access the signaling server using the first URL information and receive the TDO parameter table contains metadata information about at least one of TDO of a segment, wherein the TDO parameter table include second URL information specifying a location of a content server providing at least one of file included in the TDO and second trigger identification information identifying a trigger event included in the TDO;
a second network interface configured to access the content server using the second URL information and receive the at least one of file included in the TDO;
an widget engine configured to set the time base specified for the trigger event, set the activation time for the trigger event and activate the trigger event at the set activation time; and
a video processor configured to generate a video content including the TDO triggered by the trigger event and the program.

12. The receiver of claim 11, wherein the trigger information is received via an area for a closed caption in a video header of a broadcast signal.

13. The receiver of claim 11, wherein the TDO parameter table further includes:
trigger action information indicating a type of action for the trigger event identified by the second trigger identification information.

14. The receiver of claim 11, wherein the TDO parameter table further includes:
internet availability information indicating whether the TDO is available for downloading over an internet.

15. The receiver of claim 14, wherein the TDO parameter table further includes:
broadcast availability information indicating whether the TDO is available for extracting from a broadcast.

16. A method for processing an interactive service related to a program, the method comprising:
generating trigger information including information for operation timing of a TDO (Triggered Declarative Object), wherein the trigger information include first URI, information specifying a location of a signaling server providing a TDO parameter table, first trigger identification information identifying a trigger event included in the TDO, and at least one of first time information specifying a time base for the trigger event and second time information specifying an activation time for the trigger event;
generating the TDO parameter table contains metadata information about at least one of TDO of a segment, wherein the TDO parameter table include second URL information specifying a location of a content server providing at least one of file included in the TDO and second trigger identification information identifying a trigger event included in the TDO;
generating a signal including the generated trigger information; and
transmitting the generated TDO parameter table to the signaling server,
wherein the second trigger identification information is configured to associate the TDO parameter table with the trigger information by being matched with the first trigger identification information,
wherein the first time information is used to set the time base for the trigger event included in the TDO parameter table,
wherein the second time information is used to set the activation time for the trigger event included in the TDO parameter table.

17. The method of claim 16, wherein the generating the signal including the generated trigger information comprises:
inserting the trigger information into an area for a closed caption in a video header of a broadcast signal.

18. The method of claim 16, wherein the TDO parameter table further includes:
trigger action information indicating a type of action for the trigger event identified by the second trigger identification information.

19. The method of claim 16, wherein the TDO parameter table further includes:
internet availability information indicating whether the TDO is available for downloading over an internet.

20. The method of claim 19, wherein the TDO parameter table further includes:
broadcast availability information indicating whether the TDO is available for extracting from a broadcast.

21. The apparatus of claim 11, wherein the signal corresponds to an IP signal for delivering the trigger information via internet.

22. The method of claim 16, wherein the signal corresponds to an IP signal for delivering the trigger information via internet.
